(19) United States
(12) Patent Application Publication
(10) Pub. No.: US 2026/0086220 A1
(43) Pub. Date: Mar. 26, 2026

(54) DETERMINATION OF COMMON AZIMUTH ANGLE WITHOUT A-PRIORI ABSOLUTE REFERENCE DIRECTION KNOWLEDGE

(71) Applicant: QUALCOMM Incorporated, San Diego, CA (US)

(72) Inventors: Dan VASSILOVSKI, Del Mar, CA (US); Qing LI, Princeton Junction, NJ (US); Kapil GULATI, Belle Mead, NJ (US); Hong CHENG, Basking Ridge, NJ (US)

(21) Appl. No.: 18/895,256

(22) Filed: Sep. 24, 2024

(51) Int. Cl. G01S 13/58; G01S 5/04; G01S 13/42

(52) U.S. Cl. CPC G01S 13/58; G01S 5/04; G01S 13/42

(57) ABSTRACT

In some implementations, determining a common azimuth angle between user equipments (UEs) may be performed by a first UE, which may determine an inter-UE directional vector between the first UE and a second UE within a first coordinate frame of the first UE at a first time. In addition, the first UE may receive, from the second UE, a reference azimuth angle indicative of a relationship between the inter-UE directional vector and a second coordinate frame of the second UE. The first UE may determine, based at least in part on the reference azimuth angle and the inter-UE directional vector, a translation between the first coordinate frame and the second coordinate frame. Moreover, the first UE may obtain an azimuth angle measurement at a second time subsequent to the first time, and translate the azimuth angle measurement between the first coordinate frame and the second coordinate frame.

### BACKGROUND

### 1. Field of Disclosure

The present disclosure relates generally to the field of wireless communications and, more specifically, to radio frequency (RF)-based positioning and sensing.

### 2. Description of Related Art

RF-based positioning and sensing performed by wireless electronic devices, especially when used in a mobile communication (cellular) network, can provide significant added value to users. Mobile phones and vehicles, for example, can use such positioning to provide location-based services, such as maps and navigation. Further, determining the position of a mobile phone or vehicle can help emergency services quickly locate people in need. RF-based sensing of passive objects (objects that do not emit RF signals) can also be used in various contexts, such as determining the presence of a vehicle, obstacle, or pedestrian in a vehicular setting.

### BRIEF SUMMARY

An example method of determining a common azimuth angle between user equipments (UEs), according to this disclosure, includes determining, with a first UE, an inter-UE directional vector between the first UE and a second UE within a first coordinate frame of the first UE at a first time. The method may also include receiving, at the first UE, a reference azimuth angle from the second UE, the reference azimuth angle indicative of a relationship between the inter-UE directional vector and a second coordinate frame of the second UE at substantially the first time. The method may furthermore include determining, based at least in part on the reference azimuth angle and the inter-UE directional vector, a translation between the first coordinate frame and the second coordinate frame. The method may in addition include obtaining an azimuth angle measurement with the first UE at a second time subsequent to the first time. The method may include translating the azimuth angle measurement between the first coordinate frame and the second coordinate frame to obtain a translated azimuth angle measurement.

An example first user equipment, according to this disclosure, may include at least one transceiver, at least one memory, and at least one processor communicatively coupled with the at least one transceiver and at least one memory. The at least one processor may be configured to determine an inter-UE directional vector between the first UE and a second UE within a first coordinate frame of the first UE at a first time. The at least one processor may be configured to receive, via the at least one transceiver, a reference azimuth angle from the second UE, the reference azimuth angle indicative of a relationship between the inter-UE directional vector and a second coordinate frame of the second UE at substantially the first time. The at least one processor may be configured to determine, based at least in part on the reference azimuth angle and the inter-UE directional vector, a translation between the first coordinate frame and the second coordinate frame. The at least one processor may be configured to obtain an azimuth angle measurement with the first UE at a second time subsequent to the first time. The at least one processor may be configured to translate the azimuth angle measurement between the first coordinate frame and the second coordinate frame to obtain a translated azimuth angle measurement.

An example device, according to this disclosure, includes means for determining an inter-UE directional vector between a first user equipment (UE) and a second UE within a first coordinate frame of the first UE at a first time. The device may also include means for receiving a reference azimuth angle from the second UE, the reference azimuth angle indicative of a relationship between the inter-UE directional vector and a second coordinate frame of the second UE at substantially the first time. The device may furthermore include means for determining, based at least in part on the reference azimuth angle and the inter-UE directional vector, a translation between the first coordinate frame and the second coordinate frame. The device may, in addition, include means for obtaining an azimuth angle measurement at a second time subsequent to the first time. The device may moreover include means for translating the azimuth angle measurement between the first coordinate frame and the second coordinate frame to obtain a translated azimuth angle measurement.

This summary is neither intended to identify key or essential features of the claimed subject matter nor is it intended to be used in isolation to determine the scope of the claimed subject matter. The subject matter should be understood by reference to appropriate portions of the entire specification of this disclosure, any or all drawings, and each claim. The foregoing, together with other features and examples, will be described in more detail below in the following specification, claims, and accompanying drawings.

### BRIEF DESCRIPTION OF THE DRAWINGS

FIG. 1 is a simplified illustration of a positioning/sensing system, according to an embodiment.

FIG. 2 is a diagram of a fifth-generation new radio (5G NR) positioning/sensing system, illustrating an embodiment of a positioning/sensing system (e.g., the positioning/sensing system of FIG. 1) implemented in 5G NR.

FIGS. 3A and 3B are diagrams respectively illustrating common and relative coordinate systems of two user equipments (UEs), according to an example.

FIGS. 4A and 4B are diagrams of operations used to determine a common reference between two different coordinate systems, according to a first example.

FIGS. 5A and 5B are diagrams of operations used to determine a common reference between two different coordinate systems, according to a second example.

FIGS. 6A and 6B are diagrams of operations used to determine a common reference between two different coordinate systems, according to a third example.

FIGS. 7A and 7B are diagrams of operations used to determine a common reference between two different coordinate systems, according to a fourth example.

FIG. 8 is a flow diagram of a process that a UE may perform to establish an inter-UE directional vector with a target UE, as a reference for azimuth measurements, according to some embodiments.

FIG. 9 is an illustration of example portions of an applicable standard that may be used to determine an inter-UE directional vector between to UEs, as described herein.

FIG. 10 is a call flow diagram illustrating an example sidelink positioning protocol (SLPP) information exchange that may be used in some embodiments.

FIG. 11 is a flow diagram of a method of determining a common azimuth angle between UEs, according to an embodiment.

FIG. 12 is a block diagram of an embodiment of a user equipment.

Like reference symbols in the various drawings indicate like elements, in accordance with certain example implementations. In addition, multiple instances of an element may be indicated by following a first number for the element with a letter or a hyphen and a second number. For example, multiple instances of an element 110 may be indicated as 110-1, 110-2, 110-3 etc. or as 110a, 110b, 110c, etc. When referring to such an element using only the first number, any instance of the element is to be understood (e.g., element 110 in the previous example would refer to elements 110-1, 110-2, and 110-3 or to elements 110a, 110b, and 110c).

### DETAILED DESCRIPTION

The following description is directed to certain implementations for the purposes of describing innovative aspects of various embodiments. However, a person having ordinary skill in the art will readily recognize that the teachings herein can be applied in a multitude of different ways. The described implementations may be implemented in any device, system, or network that is capable of transmitting and receiving radio frequency (RF) signals according to any communication standard, such as any of the Institute of Electrical and Electronics Engineers (IEEE) 802.15.4 standards for ultra-wideband (UWB), IEEE 802.11 standards (including those identified as Wi-Fi® technologies), the Bluetooth® standard, code division multiple access (CDMA), frequency division multiple access (FDMA), time division multiple access (TDMA), Global System for Mobile communications (GSM), GSM/General Packet Radio Service (GPRS), Enhanced Data GSM Environment (EDGE), Terrestrial Trunked Radio (TETRA), Wideband-CDMA (W-CDMA), Evolution Data Optimized (EV-DO), 1×EV-DO, EV-DO Rev A, EV-DO Rev B, High Rate Packet Data (HRPD), High Speed Packet Access (HSPA), High Speed Downlink Packet Access (HSDPA), High Speed Uplink Packet Access (HSUPA), Evolved High Speed Packet Access (HSPA+), Long Term Evolution (LTE), Advanced Mobile Phone System (AMPS), or other known signals that are used to communicate within a wireless, cellular or internet of things (IoT) network, such as a system utilizing 3G, 4G, 5G, 6G, or further implementations thereof, technology.

As used herein, an “RF signal” comprises an electromagnetic wave that transports information through the space between a transmitter (or transmitting device) and a receiver (or receiving device). As used herein, a transmitter may transmit a single “RF signal” or multiple “RF signals” to a receiver. However, the receiver may receive multiple “RF signals” corresponding to each transmitted RF signal due to the propagation characteristics of RF signals through multiple channels or paths.

As used herein, the terms “RF sensing,” “passive RF sensing,” and variants refer to a process by which one or more objects (which also may be referred to as “targets”) are detected using RF signals transmitted by a transmitting device and, after reflecting from the object(s), received by a receiving device. In a monostatic configuration, the transmitting and receiving devices are the same device. In a bistatic configuration, one device transmits RF signals, and another device receives reflections of the RF signals from one or more objects. In multi-static configuration, one or more receiving devices are separate from one or more transmitting devices. As used herein, the term “static” in the terms “monostatic,” “bistatic,” and “multistatic” (or “multi-static”) are meant to conform with historical literature on RF sensing but are not limited to “static” or stationary sensing nodes. As described herein, in some embodiments, sensing nodes may be mobile. As described herein, devices performing RF sensing may be referred to as “RF sensing nodes” or simply “sensing nodes.” In a bistatic or multi-static configuration, transmitting devices may be referred to as “transmitting nodes,” “Tx sensing nodes,” or “Tx nodes,” and receiving devices may be referred to as “receiving nodes,” “Rx sensing nodes,” or “Rx nodes.” A sensing node may be referred to as either or both in a monostatic configuration. As described hereafter in more detail, a receiving device can make measurements of these reflected RF signals to determine one or more characteristics of one or more objects, such as location, range, angle, direction, orientation, Doppler, velocity, etc. According to some embodiments, RF sensing may be “passive” in that no RF signals need to be transmitted by the receiving device or one or more objects for the one or more objects to be detected.

Additionally, unless otherwise specified, references to “reference signals” and the like may be used to refer to signals used for positioning of a user equipment (UE), sensing of active and/or passive objects by one or more sensing nodes, or a combination thereof. As described in more detail herein, such signals may comprise any of a variety of signal types. This may include but is not limited to, a positioning reference signal (PRS), sounding reference signal (SRS), synchronization signal block (SSB), channel start information reference signal (CSI-RS), or any combination thereof.

As noted, RF-based positioning and RF-based sensing (also referred to herein simply as “RF positioning” and “RF sensing,” respectively) may be performed by wireless electronic devices (electronic devices capable of transmitting and/or receiving RF signals, also referred to herein as “wireless devices”), and can have a wide range of consumer, industrial, commercial, and other applications. The performance of RF positioning and RF sensing operations may involve one or more wireless devices, and these operations may be coordinated and/or facilitated by a wireless network. In a wireless network, wireless devices may be referred to as user equipments, or UEs. When communicating RF measurements to each other in the performance of these positioning and/or sensing operations, typically in a structured communication session, UEs often may need to communicate measurements in a particular coordinate frame.

Wireless standards developed by the 3rd Generation Partnership Project (3GPP), commonly used by mobile communications (cellular) networks worldwide, use an azimuth angle and elevation angle to express the position of an object, such as the location of a UE and/or an object sensed by a UE. Azimuth angle and elevation angle are both expressed with respect to known, absolute reference directions. In one 3GPP standard, for example, azimuth angle is defined as measured from north and elevation angle as measured from the horizontal plane (with the downward direction from the horizontal plane being towards the Earth center). However, in some scenarios, knowledge of north (e.g., WGS84 North) may be unavailable to two UEs attempting to perform RF positioning and/or RF sensing operations to, for example, determine their respective relative position and/or relative velocity. Providing a mechanism for such UEs engaged in a positioning and/or sensing session to determine a common direction reference (a common azimuth reference) absent knowledge of an absolute direction (north) is a key enabler for 3GPP RF positioning and/or RF sensing.

Embodiments described herein address these and other issues by enabling UEs communicating RF positioning and/or RF sensing information (e.g., in a positioning and/or sensing session) to determine a common reference direction for measurement of azimuth angles using an exchange of azimuthal measurements performed in coordinate systems local to the participating UEs (self-assigned by the participating UEs). The resulting reference direction can be used in RF positioning and/or RF sensing operations, such as relative position and/or relative velocity determination. According to various embodiments, the exchange of signaling can be performed over application layer signaling, or over lower layer signaling, such as Sidelink Positioning Protocol (SLPP), Radio Resource Control (RRC), PC5-RRC, etc. The signaling can be incorporated into existing standards (for example, as part of SLPP) or can be defined independently.

Particular aspects of the subject matter described in this disclosure can be implemented to realize one or more of the following potential advantages. In some examples, by providing a means by which a common reference direction can be determined between UEs, embodiments may enable RF positioning and/or RF sensing operations in scenarios in which UEs are unable to reference a common coordinate frame, such as when one or both UEs do not have knowledge of a-priori absolute reference direction. This can broaden the coverage of such RF positioning and/or RF sensing operations and applications, thereby enhancing the overall user experience. These and other advantages will be apparent to persons of ordinary skill in light of the disclosed embodiments detailed hereafter. A discussion of embodiments is provided after a brief discussion of relevant technology and context/background in which embodiments may be used.

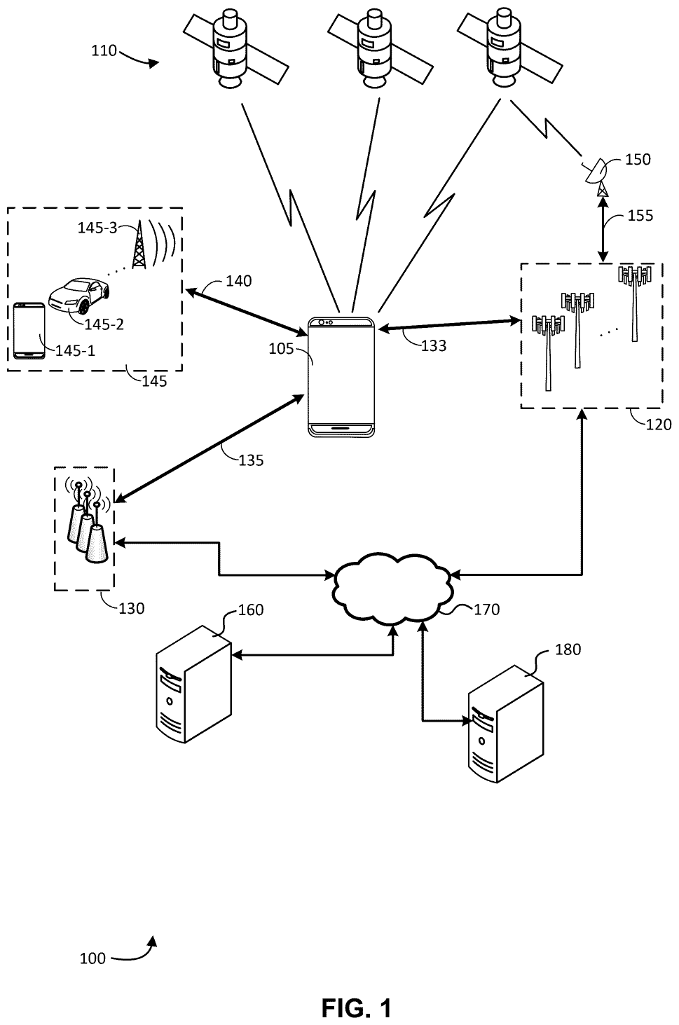

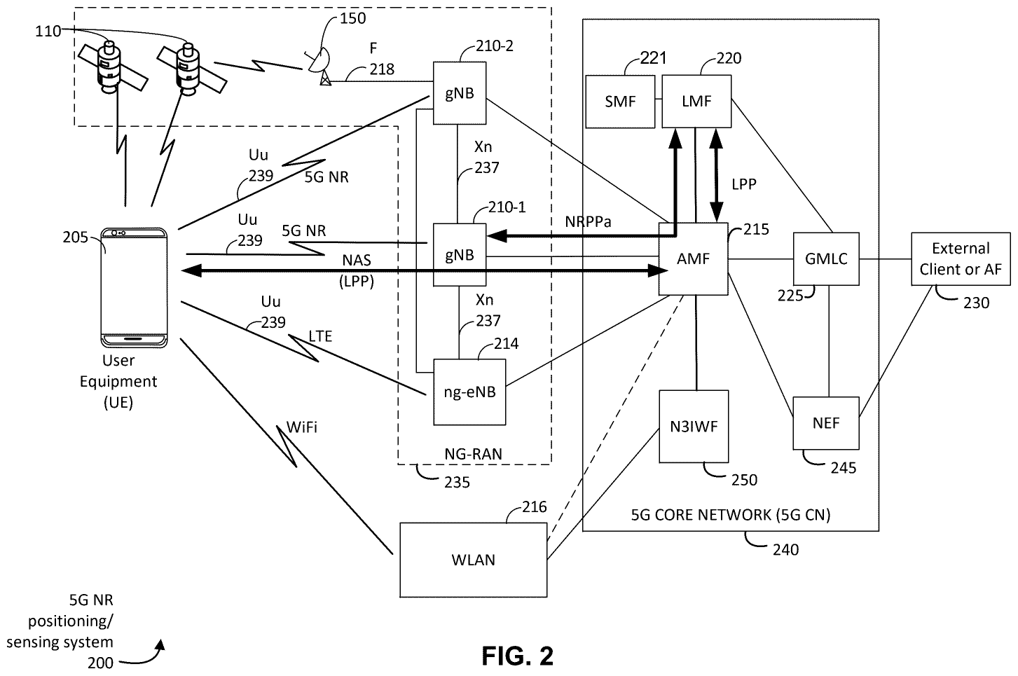

FIG. 1 is a simplified illustration of a positioning/sensing system 100, which may be implemented in conjunction with and/or as part of a wireless communication system (e.g., a cellular communication network) which a mobile device 105, location/sensing server 160, and/or other components of the positioning/sensing system 100 can use the techniques provided herein for determining a common azimuth angle without a-priori absolute reference direction knowledge, according to an embodiment. The techniques described herein may be implemented by one or more components of the positioning/sensing system 100, however, the techniques described herein are not limited to such components and may be implemented in other types of systems (not shown). The positioning/sensing system 100 can include a mobile device 105; one or more satellites 110 (also referred to as space vehicles (SVs)) for a Global Navigation Satellite System (GNSS) (such as the Global Positioning System (GPS), GLONASS, Galileo or Beidou) and/or NTN functionality; base stations 120; access points (APs) 130; location/sensing server 160; network 170; and external client 180. Generally put, the positioning/sensing system 100 can estimate the location of the mobile device 105 based on RF signals received by and/or sent from the mobile device 105 and known locations of other components (e.g., GNSS satellites 110, base stations 120, APs 130) transmitting and/or receiving the RF signals. Additionally or alternatively, wireless devices such as the mobile device 105, base stations 120, and satellites 110 (and/or other NTN platforms, which may be implemented on airplanes, drones, balloons, etc.) can be utilized to perform positioning (e.g., of one or more wireless devices) and/or perform RF sensing (e.g., of one or more objects by using RF signals transmitted by one or more wireless devices). Additional details regarding particular location estimation/sensing techniques are discussed with regard to FIG. 2.

It should be noted that FIG. 1 provides only a generalized illustration of various components, any or all of which may be utilized as appropriate, and each of which may be duplicated as necessary. Specifically, although only one mobile device 105 is illustrated, it will be understood that many UEs (e.g., hundreds, thousands, millions, etc.) may utilize the positioning/sensing system 100. Similarly, the positioning/sensing system 100 may include a larger or smaller number of base stations 120 and/or APs 130 than illustrated in FIG. 1. Although illustrated as a mobile phone, the mobile device 105 may comprise any of a variety of devices, including mobile computers (e.g., tablets, laptops, etc.), wearable devices, virtual reality (VR) and/or augmented reality (AR) devices, vehicles (e.g., consumer/industrial/commercial vehicles, aerial vehicles, nautical vehicles, etc., including electronics incorporated into and/or in communication with such vehicles), or the like. The illustrated connections that connect the various components in the positioning/sensing system 100 comprise data and signaling connections which may include additional (intermediary) components, direct or indirect physical and/or wireless connections, and/or additional networks. Furthermore, components may be rearranged, combined, separated, substituted, and/or omitted, depending on desired functionality. In some embodiments, for example, the external client 180 may be directly connected to location/sensing server 160. A person of ordinary skill in the art will recognize many modifications to the components illustrated.

Depending on desired functionality, the network 170 may comprise any of a variety of wireless and/or wireline networks. The network 170 can, for example, comprise any combination of public and/or private networks, local and/or wide-area networks, and the like. Furthermore, the network 170 may utilize one or more wired and/or wireless communication technologies. In some embodiments, the network 170 may comprise a cellular or other mobile network, a wireless local area network (WLAN), a wireless wide-area network (WWAN), and/or the Internet, for example. Examples of network 170 include a Long-Term Evolution (LTE) wireless network, a Fifth Generation (5G) wireless network (also referred to as New Radio (NR) wireless network or 5G NR wireless network), a Wi-Fi WLAN, and the Internet. LTE, 5G, and NR are wireless technologies defined, or being defined, by the 3rd Generation Partnership Project (3GPP). In an LTE, 5G, or other cellular network, mobile device 105 may be referred to as a user equipment (UE). Network 170 may also include more than one network and/or more than one type of network.

The base stations 120 and access points (APs) 130 may be communicatively coupled to the network 170. In some embodiments, the base station 120s may be owned, maintained, and/or operated by a cellular network provider, and may employ any of a variety of wireless technologies, as described herein below. Depending on the technology of the network 170, a base station 120 may comprise a node B, an Evolved Node B (eNodeB or eNB), a base transceiver station (BTS), a radio base station (RBS), an NR NodeB (gNB), a Next Generation eNB (ng-eNB), or the like. A base station 120 that is a gNB or ng-eNB may be part of a Next Generation Radio Access Network (NG-RAN) which may connect to a 5G Core Network (5GC) in the case that Network 170 is a 5G network. The functionality performed by a base station 120 in earlier-generation networks (e.g., 3G and 4G) may be separated into different functional components (e.g., radio units (RUs), distributed units (DUs), and central units (CUs)) and layers (e.g., L1/L2/L3) in view Open Radio Access Networks (O-RAN) and/or Virtualized Radio Access Network (V-RAN or vRAN) in 5G or later networks, which may be executed on different devices at different locations connected, for example, via fronthaul, midhaul, and backhaul connections. As referred to herein, a “base station” (or ng-eNB, gNB, etc.) may include any or all of these functional components. An AP 130 may comprise a Wi-Fi AP or a Bluetooth® AP or an AP having cellular capabilities (e.g., 4G LTE and/or 5G NR), for example. Thus, mobile device 105 can send and receive information with network-connected devices, such as location/sensing server 160, by accessing the network 170 via a base station 120 using a first communication link 133. Additionally or alternatively, because APs 130 also may be communicatively coupled with the network 170, mobile device 105 may communicate with network-connected and Internet-connected devices, including location/sensing server 160, using a second communication link 135, or via one or more other mobile devices 145. As used herein, the term “base station” may generically refer to a single physical transmission point, or multiple co-located physical transmission points, which may be located at a base station 120. A Transmission Reception Point (TRP) (also known as transmit/receive point) corresponds to this type of transmission point, and the term “TRP” may be used interchangeably herein with the terms “gNB,” “ng-eNB,” and “base station.” In some cases, a base station 120 may comprise multiple TRPs—e.g. with each TRP associated with a different antenna or a different antenna array for the base station 120. As used herein, the transmission functionality of a TRP may be performed with a transmission point (TP) and/or the reception functionality of a TRP may be performed by a reception point (RP), which may be physically separate or distinct from a TP. That said, a TRP may comprise both a TP and an RP. Physical transmission points may comprise an array of antennas of a base station 120 (e.g., as in a Multiple Input-Multiple Output (MIMO) system and/or where the base station employs beamforming). According to aspects of applicable 5G cellular standards, a base station 120 (e.g., gNB) may be capable of transmitting different “beams” in different directions and performing “beam sweeping” in which a signal is transmitted in different beams, along different directions (e.g., one after the other). The term “base station” used herein may additionally refer to multiple non-co-located physical transmission points, the physical transmission points may be a Distributed Antenna System (DAS) (a network of spatially separated antennas connected to a common source via a transport medium) or a Remote Radio Head (RRH) (a remote base station connected to a serving base station).

As noted, satellites 110 may be used to implement NTN functionality, extending communication, positioning, and potentially other functionality (e.g., RF sensing) of a terrestrial network. As such, one or more satellites may be communicatively linked to one or more NTN gateways 150 (also known as “gateways,” “earth stations,” or “ground stations”). The NTN gateways 150 may be communicatively linked with base stations 120 via link 155. In some embodiments, NTN gateways 150 may function as DUs of a base station 120, as described previously. Not only can this enable the mobile device 105 to communicate with the network 170 via satellites 110, but this can also enable network-based positioning, RF sensing, etc.

Satellites 110 may be utilized in one or more way. For example, satellites 110 (also referred to as space vehicles (SVs)) may be part of a Global Navigation Satellite System (GNSS) such as the Global Positioning System (GPS), GLONASS, Galileo or Beidou. Positioning using RF signals from GNSS satellites may comprise measuring multiple GNSS signals at a GNSS receiver of the mobile device 105 to perform code-based and/or carrier-based positioning, which can be highly accurate. Additionally or alternatively, satellites 110 may be utilized for NTN-based positioning, in which satellites 110 may functionally operate as TRPs (or TPs) of a network (e.g., LTE and/or NR network) and may be communicatively coupled with network 170. In particular, reference signals (e.g., PRS) transmitted by satellites 110 NTN-based positioning may be similar to those transmitted by base stations 120 and may be coordinated by a network function server 160, which may operate as a location server. In some embodiments, satellites 110 used for NTN-based positioning may be different than those used for GNSS-based positioning. In some embodiments NTN nodes may include non-terrestrial vehicles such as airplanes, balloons, drones, etc., which may be in addition or as an alternative to NTN satellites. NTN satellites 110 and/or other NTN platforms may be further leveraged to perform RF sensing. As described in more detail hereafter, satellites may use a JCS symbol in an Orthogonal Frequency-Division Multiplexing (OFDM) waveform to allow both RF sensing and/or positioning, and communication.

As used herein, the term “cell” may generically refer to a logical communication entity used for communication with a base station 120 and may be associated with an identifier for distinguishing neighboring cells (e.g., a Physical Cell Identifier (PCID), a Virtual Cell Identifier (VCID)) operating via the same or a different carrier. In some examples, a carrier may support multiple cells, and different cells may be configured according to different protocol types (e.g., Machine-Type Communication (MTC), Narrowband Internet-of-Things (NB-IoT), Enhanced Mobile Broadband (cMBB), or others) that may provide access for different types of devices. In some cases, the term “cell” may refer to a portion of a geographic coverage area (e.g., a sector) over which the logical entity operates.

The location/sensing server 160 may comprise a server and/or other computing device configured to determine an estimated location of mobile device 105 and/or provide data (e.g., “assistance data”) to mobile device 105 to facilitate location measurement and/or location determination by mobile device 105. According to some embodiments, location/sensing server 160 may comprise a Home Secure User Plane Location (SUPL) Location Platform (H-SLP), which may support the SUPL user plane (UP) location solution defined by the Open Mobile Alliance (OMA) and may support location services for mobile device 105 based on subscription information for mobile device 105 stored in location/sensing server 160. In some embodiments, the location/sensing server 160 may comprise, a Discovered SLP (D-SLP) or an Emergency SLP (E-SLP). The location/sensing server 160 may also comprise an Enhanced Serving Mobile Location Center (E-SMLC) that supports location of mobile device 105 using a control plane (CP) location solution for LTE radio access by mobile device 105. The location/sensing server 160 may further comprise a Location Management Function (LMF) that supports location of mobile device 105 using a control plane (CP) location solution for NR or LTE radio access by mobile device 105.

In a CP location solution, signaling to control and manage the location of mobile device 105 may be exchanged between elements of network 170 and with mobile device 105 using existing network interfaces and protocols and as signaling from the perspective of network 170. In a UP location solution, signaling to control and manage the location of mobile device 105 may be exchanged between location/sensing server 160 and mobile device 105 as data (e.g. data transported using the Internet Protocol (IP) and/or Transmission Control Protocol (TCP)) from the perspective of network 170.

As previously noted (and discussed in more detail below), the estimated location of mobile device 105 may be based on measurements of RF signals sent from and/or received by the mobile device 105. In particular, these measurements can provide information regarding the relative distance and/or angle of the mobile device 105 from one or more components in the positioning/sensing system 100 (e.g., satellites 110, APs 130, base stations 120). As explained in more detail below, measurements can include measurements of RF signals exchanged between the mobile device 105 and one or more other mobile devices 145. The estimated location of the mobile device 105 can be estimated geometrically (e.g., using multiangulation and/or multilateration), based on the distance (range) and/or angle measurements, along with known position of the one or more components.

Additionally or alternatively, the location/sensing server 160, may function as a sensing server. A sensing server can be used to coordinate and/or assist in the coordination of sensing of one or more objects (also referred to herein as “targets”) by one or more wireless devices in the positioning/sensing system 100. This can include the mobile device 105, base stations 120, APs 130, other mobile devices 145, satellites 110, or any combination thereof. Wireless devices capable of performing RF sensing may be referred to herein as “sensing nodes.” To perform RF sensing, a sensing server may coordinate sensing sessions in which one or more RF sensing nodes may perform RF sensing by transmitting RF signals (e.g., reference signals (RSS)), and measuring reflected signals, or “echoes,” comprising reflections of the transmitted RF signals off of one or more objects/targets. Reflected signals and object/target detection may be determined, for example, from channel state information (CSI) received at a receiving device. Sensing may comprise (i) monostatic sensing using a single device as a transmitter (of RF signals) and receiver (of reflected signals); (ii) bistatic sensing using a first device as a transmitter and a second device as a receiver; or (iii) multi-static sensing using a plurality of transmitters and/or a plurality of receivers. To facilitate sensing (e.g., in a sensing session among one or more sensing nodes), a sensing server may provide data (e.g., “assistance data”) to the sensing nodes to facilitate RS transmission and/or measurement, object/target detection, or any combination thereof. Such data may include an RS configuration indicating which resources (e.g., time and/or frequency resources) may be used (e.g., in a sensing session) to transmit RS for RF sensing. According to some embodiments, a sensing server may comprise a Sensing Management Function (SMF or SnMF).

Although terrestrial components such as APs 130 and base stations 120 may be fixed, embodiments are not so limited. Mobile components may be used. For example, in some embodiments, a location of the mobile device 105 may be estimated at least in part based on measurements of RF signals 140 communicated between the mobile device 105 and one or more other mobile devices 145, which may be mobile or fixed. As illustrated, other mobile devices may include, for example, a mobile phone 145-1, vehicle 145-2, static communication/positioning device 145-3, or other static and/or mobile device capable of providing wireless signals used for positioning the mobile device 105, or a combination thereof. Wireless signals from mobile devices 145 used for positioning of the mobile device 105 may comprise RF signals using, for example, Bluetooth® (including Bluetooth Low Energy (BLE)), IEEE 802.11x (e.g., Wi-Fi®), Ultra-Wideband (UWB), IEEE 802.15x, 3GPP and/or other cellular RF signals, or a combination thereof. Mobile devices 145 may additionally or alternatively use non-RF wireless signals for positioning of the mobile device 105, such as infrared signals or other optical technologies.

Mobile devices 145 may comprise other UEs communicatively coupled with a cellular or other mobile network (e.g., network 170). When one or more other mobile devices 145 comprising UEs are used in the position determination of a particular mobile device 105, the mobile device 105 for which the position is to be determined may be referred to as the “target UE,” and each of the other mobile devices 145 used may be referred to as an “anchor UE.” For position determination of a target UE, the respective positions of the one or more anchor UEs may be known and/or jointly determined with the target UE. Direct communication between the one or more other mobile devices 145 and mobile device 105 may comprise sidelink and/or similar Device-to-Device (D2D) communication technologies. Sidelink, which is defined by 3GPP, is a form of D2D communication under the cellular-based LTE and NR standards.

According to some embodiments, such as when the mobile device 105 comprises and/or is incorporated into a vehicle, a form of D2D communication used by the mobile device 105 may comprise vehicle-to-everything (V2X) communication. V2X is a communication standard for vehicles and related entities to exchange information regarding a traffic environment. V2X can include vehicle-to-vehicle (V2V) communication between V2X-capable vehicles, vehicle-to-infrastructure (V2I) communication between the vehicle and infrastructure-based devices (commonly termed roadside units (RSUs)), vehicle-to-person (V2P) communication between vehicles and nearby people (pedestrians, cyclists, and other road users), and the like. Further, V2X can use any of a variety of wireless RF communication technologies. Cellular V2X (CV2X), for example, is a form of V2X that uses cellular-based communication such as LTE (4G), NR (5G) and/or other cellular technologies in a direct-communication mode as defined by 3GPP. The mobile device 105 illustrated in FIG. 1 may correspond to a component or device on a vehicle, RSU, or other V2X entity that is used to communicate V2X messages. In embodiments in which V2X is used, the static communication/positioning device 145-3 (which may correspond with an RSU) and/or the vehicle 145-2, therefore, may communicate with the mobile device 105 and may be used to determine the position of the mobile device 105 using techniques similar to those used by base stations 120 and/or APs 130 (e.g., using multiangulation and/or multilateration). It can be further noted that mobile devices 145 (which may include V2X devices), base stations 120, and/or APs 130 may be used together (e.g., in a WWAN positioning solution) to determine the position of the mobile device 105, according to some embodiments.

An estimated location of mobile device 105 can be used in a variety of applications—e.g. to assist direction finding or navigation for a user of mobile device 105 or to assist another user (e.g. associated with external client 180) to locate mobile device 105. A “location” is also referred to herein as a “location estimate,” “estimated location,” “location,” “position,” “position estimate,” “position fix,” “estimated position,” “location fix” or “fix.” The process of determining a location may be referred to as “positioning,” “position determination,” “location determination,” or the like. A location of mobile device 105 may comprise an absolute location of mobile device 105 (e.g. a latitude and longitude and possibly altitude) or a relative location of mobile device 105 (e.g. a location expressed as distances north or south, east or west and possibly above or below some other known fixed location (including, e.g., the location of a base station 120 or AP 130) or some other location such as a location for mobile device 105 at some known previous time, or a location of a mobile device 145 (e.g., another UE) at some known previous time). A location may be specified as a geodetic location comprising coordinates which may be absolute (e.g. latitude, longitude and optionally altitude), relative (e.g. relative to some known absolute location) or local (e.g. X, Y and optionally Z coordinates according to a coordinate system defined relative to a local area such a factory, warehouse, college campus, shopping mall, sports stadium or convention center). A location may instead be a civic location and may then comprise one or more of a street address (e.g. including names or labels for a country, state, county, city, road and/or street, and/or a road or street number), and/or a label or name for a place, building, portion of a building, floor of a building, and/or room inside a building etc. A location may further include an uncertainty or error indication, such as a horizontal and possibly vertical distance by which the location is expected to be in error or an indication of an area or volume (e.g. a circle or ellipse) within which mobile device 105 is expected to be located with some level of confidence (e.g. 95% confidence).

The external client 180 may be a web server or remote application that may have some association with mobile device 105 (e.g. may be accessed by a user of mobile device 105) or may be a server, application, or computer system providing a location service to some other user or users which may include obtaining and providing the location of mobile device 105 (e.g. to enable a service such as friend or relative finder, or child or pet location). Additionally or alternatively, the external client 180 may obtain and provide the location of mobile device 105 to an emergency services provider, government agency, etc.

As previously noted, the example positioning/sensing system 100 can be implemented using a wireless communication network, such as an LTE-based or 5G NR-based network, or a future 6G network. FIG. 2 shows a diagram of a 5G NR positioning/sensing system 200, illustrating an embodiment of a positioning/sensing system (e.g., positioning/sensing system 100) implemented in 5G NR. The 5G NR positioning/sensing system 200 may be configured to enable wireless communication, determine the location of a UE 205 (which may correspond to the mobile device 105 of FIG. 1), perform RF sensing, or a combination thereof, by using access nodes, which may include NR NodeB (gNB) 210-1 and 210-2 (collectively and generically referred to herein as gNBs 210), ng-eNB 214, and/or WLAN 216 to implement one or more positioning methods. These access nodes can use RF signaling to enable the communication, implement one or more positioning methods, and/or implement RF sensing. The gNBs 210 and/or the ng-eNB 214 may correspond with base stations 120 of FIG. 1, and the WLAN 216 may correspond with one or more access points 130 of FIG. 1. Optionally, the 5G NR positioning/sensing system 200 additionally may be configured to determine the location of a UE 205 by using an LMF 220 (which may correspond with location/sensing server 160) to implement the one or more positioning methods. The SMF 221 may coordinate RF sensing by the 5G NR positioning/sensing system 200. Here, the 5G NR positioning/sensing system 200 comprises a UE 205, and components of a 5G NR network comprising a Next Generation (NG) Radio Access Network (RAN) (NG-RAN) 235 and a 5G Core Network (5G CN) 240. A 5G network may also be referred to as an NR network; NG-RAN 235 may be referred to as a 5G RAN or as an NR RAN; and 5G CN 240 may be referred to as an NG Core network. Additional components of the 5G NR positioning/sensing system 200 are described below. The 5G NR positioning/sensing system 200 may include additional or alternative components.

The 5G NR positioning/sensing system 200 may further utilize information from satellites 110. As previously indicated, satellites 110 may comprise GNSS satellites from a GNSS system like Global Positioning/sensing system (GPS) or similar system (e.g. GLONASS, Galileo, Beidou, Indian Regional Navigational Satellite System (IRNSS)). Additionally or alternatively, satellites 110 may comprise NTN satellites. NTN satellites may be in low earth orbit (LEO), medium earth orbit (MEO), geostationary earth orbit (GEO) or some other type of orbit. NTN satellites may be communicatively coupled with the LMF 220 and may operatively function as a TRP (or TP) in the NG-RAN 235. As such, satellites 110 may be in communication with one or more gNBs 210 via one or more NTN gateways 150. According to some embodiments, an NTN gateway 150 may operate as a DU of a gNB 210, in which case communications between NTN gateway 150 and CU of the gNB 210 may occur over an F interface 218 between DU and CU.

It should be noted that FIG. 2 provides only a generalized illustration of various components, any or all of which may be utilized as appropriate, and each of which may be duplicated or omitted, as necessary. Specifically, although only one UE 205 is illustrated, it will be understood that many UEs (e.g., hundreds, thousands, millions, etc.) may utilize the 5G NR positioning/sensing system 200. Similarly, the 5G NR positioning/sensing system 200 may include a larger (or smaller) number of satellites 110, gNBs 210, ng-eNBs 214, Wireless Local Area Networks (WLANs) 216, Access and mobility Management Functions (AMF) s 215, external clients 230, and/or other components. The illustrated connections that connect the various components in the 5G NR positioning/sensing system 200 include data and signaling connections which may include additional (intermediary) components, direct or indirect physical and/or wireless connections, and/or additional networks. Furthermore, components may be rearranged, combined, separated, substituted, and/or omitted, depending on desired functionality.

The UE 205 may comprise and/or be referred to as a device, a mobile device, a wireless device, a mobile terminal, a terminal, a mobile station (MS), a Secure User Plane Location (SUPL)-Enabled Terminal (SET), or by some other name. Moreover, UE 205 may correspond to a cellphone, smartphone, laptop, tablet, personal data assistant (PDA), navigation device, Internet of Things (IoT) device, or some other portable or moveable device. Typically, though not necessarily, the UE 205 may support wireless communication using one or more Radio Access Technologies (RATs) such as using GSM, CDMA, W-CDMA, LTE, High-Rate Packet Data (HRPD), IEEE 802.11 Wi-Fi®, Bluetooth, Worldwide Interoperability for Microwave Access (WiMAX™), 5G NR (e.g., using the NG-RAN 235 and 5G CN 240), etc. The UE 205 may also support wireless communication using a WLAN 216 which (like the one or more RATs, and as previously noted with respect to FIG. 1) may connect to other networks, such as the Internet. The use of one or more of these RATs may allow the UE 205 to communicate with an external client 230 (e.g., via elements of 5G CN 240 not shown in FIG. 2, or possibly via a Gateway Mobile Location Center (GMLC) 225) and/or allow the external client 230 to receive location information regarding the UE 205 (e.g., via the GMLC 225). The external client 230 of FIG. 2 may correspond to external client 180 of FIG. 1, as implemented in or communicatively coupled with a 5G NR network.

The UE 205 may include a single entity or may include multiple entities, such as in a personal area network where a user may employ audio, video and/or data I/O devices, and/or body sensors and a separate wireline or wireless modem. An estimate of a location of the UE 205 may be referred to as a location, location estimate, location fix, fix, position, position estimate, or position fix, and may be geodetic, thus providing location coordinates for the UE 205 (e.g., latitude and longitude), which may or may not include an altitude component (e.g., height above sea level, height above or depth below ground level, floor level or basement level). Alternatively, a location of the UE 205 may be expressed as a civic location (e.g., as a postal address or the designation of some point or small area in a building such as a particular room or floor). A location of the UE 205 may also be expressed as an area or volume (defined either geodetically or in civic form) within which the UE 205 is expected to be located with some probability or confidence level (e.g., 67%, 95%, etc.). A location of the UE 205 may further be a relative location comprising, for example, a distance and direction or relative X, Y (and Z) coordinates defined relative to some origin at a known location which may be defined geodetically, in civic terms, or by reference to a point, area, or volume indicated on a map, floor plan or building plan. In the description contained herein, the use of the term location may comprise any of these variants unless indicated otherwise. When computing the location of a UE, it is common to solve for local X, Y, and possibly Z coordinates and then, if needed, convert the local coordinates into absolute ones (e.g. for latitude, longitude and altitude above or below mean sea level).

Base stations in the NG-RAN 235 shown in FIG. 2 may correspond to base stations 120 in FIG. 1 and may include gNBs 210. Pairs of gNBs 210 in NG-RAN 235 may be connected to one another (e.g., directly as shown in FIG. 2 or indirectly via other gNBs 210). The communication interface between base stations (gNBs 210 and/or ng-cNB 214) may be referred to as an Xn interface 237. Access to the 5G network is provided to UE 205 via wireless communication between the UE 205 and one or more of the gNBs 210, which may provide wireless communications access to the 5G CN 240 on behalf of the UE 205 using 5G NR. The wireless interface between base stations (gNBs 210 and/or ng-eNB 214) and the UE 205 may be referred to as a Uu interface 239. 5G NR radio access may also be referred to as NR radio access or as 5G radio access. In FIG. 2, the serving gNB for UE 205 is assumed to be gNB 210-1, although other gNBs (e.g. gNB 210-2) may act as a serving gNB if UE 205 moves to another location or may act as a secondary gNB to provide additional throughput and bandwidth to UE 205.

Base stations in the NG-RAN 235 shown in FIG. 2 may also or instead include a next generation evolved Node B, also referred to as an ng-eNB, 214. Ng-eNB 214 may be connected to one or more gNBs 210 in NG-RAN 235—e.g. directly or indirectly via other gNBs 210 and/or other ng-eNBs. An ng-eNB 214 may provide LTE wireless access and/or evolved LTE (cLTE) wireless access to UE 205. Some gNBs 210 (e.g. gNB 210-2) and/or ng-eNB 214 in FIG. 2 may be configured to function as positioning-only beacons which may transmit signals (e.g., Positioning Reference Signal (PRS)) and/or may broadcast assistance data to assist positioning of UE 205 but may not receive signals from UE 205 or from other UEs. Some gNBs 210 (e.g., gNB 210-2 and/or another gNB not shown) and/or ng-eNB 214 may be configured to function as detecting-only nodes may scan for signals containing, e.g., PRS data, assistance data, or other location data. Such detecting-only nodes may not transmit signals or data to UEs but may transmit signals or data (relating to, e.g., PRS, assistance data, or other location data) to other network entities (e.g., one or more components of 5G CN 240, external client 230, or a controller) which may receive and store or use the data for positioning of at least UE 205. It is noted that while only one ng-eNB 214 is shown in FIG. 2, some embodiments may include multiple ng-eNBs 214. Base stations (e.g., gNBs 210 and/or ng-NB 214) may communicate directly with one another via an Xn communication interface. Additionally or alternatively, base stations may communicate directly or indirectly with other components of the 5G NR positioning/sensing system 200, such as the LMF 220 and AMF 215.

5G NR positioning/sensing system 200 may also include one or more WLANs 216 which may connect to a Non-3GPP InterWorking Function (N3IWF) 250 in the 5G CN 240 (e.g., in the case of an untrusted WLAN 216). For example, the WLAN 216 may support IEEE 802.11 Wi-Fi access for UE 205 and may comprise one or more Wi-Fi APs (e.g., APs 130 of FIG. 1). Here, the N3IWF 250 may connect to other elements in the 5G CN 240 such as AMF 215. In some embodiments, WLAN 216 may support another RAT such as Bluetooth. The N3IWF 250 may provide support for secure access by UE 205 to other elements in 5G CN 240 and/or may support interworking of one or more protocols used by WLAN 216 and UE 205 to one or more protocols used by other elements of 5G CN 240 such as AMF 215. For example, N3IWF 250 may support IPSec tunnel establishment with UE 205, termination of IKEv2/IPSec protocols with UE 205, termination of N2 and N3 interfaces to 5G CN 240 for control plane and user plane, respectively, relaying of uplink (UL) and downlink (DL) control plane Non-Access Stratum (NAS) signaling between UE 205 and AMF 215 across an N1 interface. In some other embodiments, WLAN 216 may connect directly to elements in 5G CN 240 (e.g. AMF 215 as shown by the dashed line in FIG. 2) and not via N3IWF 250. For example, direct connection of WLAN 216 to 5GCN 240 may occur if WLAN 216 is a trusted WLAN for 5GCN 240 and may be enabled using a Trusted WLAN Interworking Function (TWIF) (not shown in FIG. 2) which may be an element inside WLAN 216. It is noted that while only one WLAN 216 is shown in FIG. 2, some embodiments may include multiple WLANs 216.

Access nodes may comprise any of a variety of network entities enabling communication between the UE 205 and the AMF 215. As noted, this can include gNBs 210, ng-eNB 214, WLAN 216, and/or other types of cellular base stations, and may also include NTN satellites 110. However, access nodes providing the functionality described herein may additionally or alternatively include entities enabling communications to any of a variety of RATs not illustrated in FIG. 2, which may include non-cellular technologies. Thus, the term “access node,” as used in the embodiments described herein below, may include but is not necessarily limited to a gNB 210, ng-eNB 214, WLAN 216, or NTN satellite 110.

In some embodiments, an access node, such as a gNB 210, ng-eNB 214, WLAN 216, or NTN satellite 110, or a combination thereof, (alone or in combination with other components of the 5G NR positioning/sensing system 200), may be configured to, in response to receiving a request for location information from the LMF 220, obtain location measurements of uplink (UL) signals received from the UE 205) and/or obtain downlink (DL) location measurements from the UE 205 that were obtained by UE 205 for DL signals received by UE 205 from one or more access nodes. As noted, while FIG. 2 depicts access nodes (gNB 210, ng-eNB 214, WLAN 216, and NTN satellite 110) configured to communicate according to 5G NR, LTE, and Wi-Fi communication protocols, respectively, access nodes configured to communicate according to other communication protocols may be used, such as, for example, a Node B using a Wideband Code Division Multiple Access (WCDMA) protocol for a Universal Mobile Telecommunications Service (UMTS) Terrestrial Radio Access Network (UTRAN), an eNB using an LTE protocol for an Evolved UTRAN (E-UTRAN), or a Bluetooth® beacon using a Bluetooth protocol for a WLAN. For example, in a 4G Evolved Packet System (EPS) providing LTE wireless access to UE 205, a RAN may comprise an E-UTRAN, which may comprise base stations comprising eNBs supporting LTE wireless access. A core network for EPS may comprise an Evolved Packet Core (EPC). An EPS may then comprise an E-UTRAN plus an EPC, where the E-UTRAN corresponds to NG-RAN 235 and the EPC corresponds to 5GCN 240 in FIG. 2. The methods and techniques described herein for obtaining a civic location for UE 205 may be applicable to such other networks.

The gNBs 210 and ng-eNB 214 can communicate with an AMF 215, which, for positioning functionality, communicates with an LMF 220. The AMF 215 may support mobility of the UE 205, including cell change and handover of UE 205 from an access node (e.g., gNB 210, ng-eNB 214, WLAN 216, or NTN satellite 110) of a first RAT to an access node of a second RAT. The AMF 215 may also participate in supporting a signaling connection to the UE 205 and possibly data and voice bearers for the UE 205. The LMF 220 may support positioning of the UE 205 using a CP location solution when UE 205 accesses the NG-RAN 235 or WLAN 216 and may support position procedures and methods, including UE assisted/UE based and/or network based procedures/methods, such as Assisted GNSS (A-GNSS), Observed Time Difference Of Arrival (OTDOA) (which may be referred to in NR as Time Difference Of Arrival (TDOA)), Frequency Difference Of Arrival (FDOA), Real Time Kinematic (RTK), Precise Point Positioning (PPP), Differential GNSS (DGNSS), Enhance Cell ID (ECID), angle of arrival (AoA), angle of departure (AoD), WLAN positioning, round trip signal propagation delay (RTT), multi-cell RTT, and/or other positioning procedures and methods. The LMF 220 may also process location service requests for the UE 205, e.g., received from the AMF 215 or from the GMLC 225. The LMF 220 may be connected to AMF 215 and/or to GMLC 225. In some embodiments, a network such as 5GCN 240 may additionally or alternatively implement other types of location-support modules, such as an Evolved Serving Mobile Location Center (E-SMLC) or a SUPL Location Platform (SLP). It is noted that in some embodiments, at least part of the positioning functionality (including determination of a UE 205's location) may be performed at the UE 205 (e.g., by measuring downlink PRS (DL-PRS) signals transmitted by wireless nodes such gNB 210, ng-NB 214, WLAN 216, or NTN satellite 110, and/or using assistance data provided to the UE 205, e.g., by LMF 220).

The Gateway Mobile Location Center (GMLC) 225 may support a location request for the UE 205 received from an external client 230 and may forward such a location request to the AMF 215 for forwarding by the AMF 215 to the LMF 220. A location response from the LMF 220 (e.g., containing a location estimate for the UE 205) may be similarly returned to the GMLC 225 either directly or via the AMF 215, and the GMLC 225 may then return the location response (e.g., containing the location estimate) to the external client 230.

A Network Exposure Function (NEF) 245 may be included in 5GCN 240. The NEF 245 may support secure exposure of capabilities and events concerning 5GCN 240 and UE 205 to the external client 230, which may then be referred to as an Access Function (AF) and may enable the secure provision of information from the external client 230 to 5GCN 240. NEF 245 may be connected to AMF 215 and/or to GMLC 225 for the purposes of obtaining a location (e.g. a civic location) of UE 205 and providing the location to external client 230.

As further illustrated in FIG. 2, the LMF 220 may communicate with the gNBs 210 and/or with the ng-eNB 214 using an NR Positioning Protocol annex (NRPPa) as defined in 3GPP Technical Specification (TS) 38.455. NRPPa messages may be transferred between a gNB 210 and the LMF 220, and/or between an ng-eNB 214 and the LMF 220, via the AMF 215. As further illustrated in FIG. 2, LMF 220 and UE 205 may communicate using an LTE Positioning Protocol (LPP) as defined in 3GPP TS 37.355. Here, LPP messages may be transferred between the UE 205 and the LMF 220 via the AMF 215 and a serving gNB 210-1 or serving ng-eNB 214 for UE 205. For example, LPP messages may be transferred between the LMF 220 and the AMF 215 using messages for service-based operations (e.g., based on the Hypertext Transfer Protocol (HTTP)) and may be transferred between the AMF 215 and the UE 205 using a 5G NAS protocol. The LPP protocol may be used to support positioning of UE 205 using UE assisted and/or UE-based position methods such as A-GNSS, RTK, TDOA, multi-cell RTT, AoD, and/or ECID. The NRPPa protocol may be used to support positioning of UE 205 using network-based position methods such as ECID, AoA, uplink TDOA (UL-TDOA) and/or may be used by LMF 220 to obtain location-related information from gNBs 210 and/or ng-eNB 214, such as parameters defining DL-PRS transmission from gNBs 210 and/or ng-cNB 214.

In the case of UE 205 access to WLAN 216, LMF 220 may use NRPPa and/or LPP to obtain a location of UE 205 in a similar manner to that just described for UE 205 access to a gNB 210 or ng-eNB 214. Thus, NRPPa messages may be transferred between a WLAN 216 and the LMF 220, via the AMF 215 and N3IWF 250 to support network-based positioning of UE 205 and/or transfer of other location information from WLAN 216 to LMF 220. Alternatively, NRPPa messages may be transferred between N3IWF 250 and the LMF 220, via the AMF 215, to support network-based positioning of UE 205 based on location-related information and/or location measurements known to or accessible to N3IWF 250 and transferred from N3IWF 250 to LMF 220 using NRPPa. Similarly, LPP and/or LPP messages may be transferred between the UE 205 and the LMF 220 via the AMF 215, N3IWF 250, and serving WLAN 216 for UE 205 to support UE-assisted or UE-based positioning of UE 205 by LMF 220.

In a 5G NR positioning/sensing system 200, positioning and sensing methods can be categorized as being “UE assisted” or “UE based.” This may depend on where the request for determining the position of the UE 205 originated. If, for example, the request originated at the UE (e.g., from an application, or “app,” executed by the UE), the positioning method may be categorized as being UE based. If, on the other hand, the request originates from an external client 230, LMF 220, or other device or service within the 5G network, the positioning method may be categorized as being UE assisted (or “network-based”).

With a UE-assisted position method, UE 205 may obtain location measurements and send the measurements to a location server (e.g., LMF 220) for computation of a location estimate for UE 205. For RAT-dependent position methods location measurements may include one or more of a Received Signal Strength Indicator (RSSI), Round Trip signal propagation Time (RTT), Reference Signal Received Power (RSRP), Reference Signal Received Quality (RSRQ), RSTD, Time of Arrival (TOA), AoA, Receive Time-Transmission Time Difference (Rx-Tx), Differential AoA (DAOA), AoD, or Timing Advance (TA) for gNBs 210, ng-eNB 214, and/or one or more access points for WLAN 216. Additionally or alternatively, similar measurements may be made of sidelink signals transmitted by other UEs, which may serve as anchor points for positioning of the UE 205 if the positions of the other UEs are known. The location measurements may also or instead include measurements for RAT-independent positioning methods such as GNSS (e.g., GNSS pseudorange, GNSS code phase, and/or GNSS carrier phase for GNSS satellites), WLAN, etc.

With a UE-based position method, UE 205 may obtain location measurements (e.g., which may be the same as or similar to location measurements for a UE-assisted position method) and may further compute a location of UE 205 (e.g., with the help of assistance data received from a location server such as LMF 220, an SLP, or broadcast by gNBs 210, ng-cNB 214, or WLAN 216).

With a network-based position method, one or more base stations (e.g., gNBs 210 and/or ng-eNB 214), one or more APs (e.g., in WLAN 216), or N3IWF 250 may obtain location measurements (e.g., measurements of RSSI, RTT, RSRP, RSRQ, AoA, or TOA) for signals transmitted by UE 205, and/or may receive measurements obtained by UE 205 or by an AP in WLAN 216 in the case of N3IWF 250, and may send the measurements to a location server (e.g., LMF 220) for computation of a location estimate for UE 205.

Positioning of the UE 205 also may be categorized as UL, DL, or DL-UL based, depending on the types of signals used for positioning. If, for example, positioning is based solely on signals received at the UE 205 (e.g., from a base station or other UE), the positioning may be categorized as DL based. On the other hand, if positioning is based solely on signals transmitted by the UE 205 (which may be received by a base station or other UE, for example), the positioning may be categorized as UL based. Positioning that is DL-UL based includes positioning, such as RTT-based positioning, which is based on signals that are both transmitted and received by the UE 205. Sidelink (SL)-assisted positioning comprises signals communicated between the UE 205 and one or more other UEs. According to some embodiments, UL, DL, or DL-UL positioning as described herein may be capable of using SL signaling as a complement or replacement of SL, DL, or DL-UL signaling.

Depending on the type of positioning (e.g., UL, DL, or DL-UL based) the types of reference signals used can vary. For DL-based positioning, for example, these signals may comprise PRS (e.g., DL-PRS transmitted by base stations or SL-PRS transmitted by other UEs), which can be used for TDOA, AoD, and RTT measurements. Other reference signals that can be used for positioning (UL, DL, or DL-UL) may include Sounding Reference Signal (SRS), Channel State Information Reference Signal (CSI-RS), synchronization signals (e.g., synchronization signal block (SSB) Synchronizations Signal (SS)), Physical Uplink Control Channel (PUCCH), Physical Uplink Shared Channel (PUSCH), Physical Sidelink Shared Channel (PSSCH), Demodulation Reference Signal (DMRS), etc. Moreover, reference signals may be transmitted in a Tx beam and/or received in an Rx beam (e.g., using beamforming techniques), which may impact angular measurements, such as AoD and/or AoA.

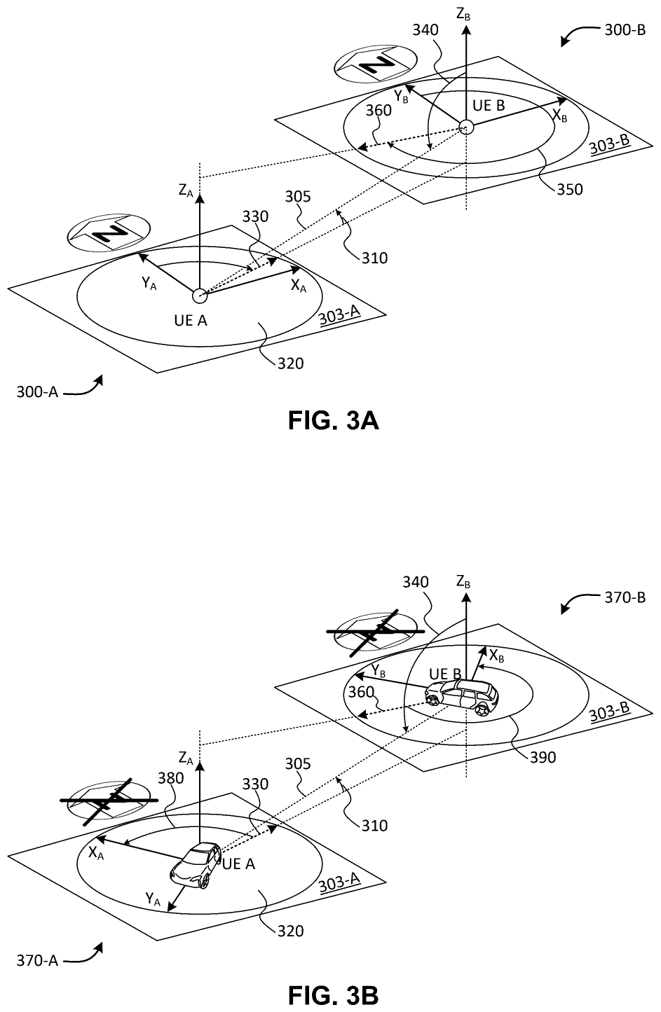

The principles described above with respect to positioning may be generally extended to RF sensing. That is, RF sensing may be UE-based (e.g., originated from the UE) and/or UE assisted (e.g., originated from a non-UE entity), and may involve UL signals, DL signals, or both (or SL signals in addition or as an alternative to UL and/or DL signals, as noted above). However, RF sensing may differ from positioning in various ways. For example, as previously noted and described in more detail below, RF sensing may involve the use of specific RF sensing signals. Further, RF sensing may be performed in a monostatic, bistatic, or multi-static manner, as described above, where RF sensing nodes comprise a UE (e.g., UE 205) and/or one or more access nodes (e.g., gNBs 210, ng-NB 214, WLAN 216, NTN satellites 110, or any combination thereof). Various aspects of RF sensing are described below in more detail with respect to FIG. 3.

As noted previously, when communicating information such as measurements made in the course of RF positioning and/or RF sensing, UEs may provide azimuth measurements with respect to a common coordinate system. Without a common coordinate system as a point of reference, a receiving UE would be unable to use an azimuth measurement transmitted by a transmitting UE (e.g., for purposes of determining the position of a UE or a sensed object). FIGS. 3A and 3B help illustrate this problem.

FIG. 3A is an illustration of an example relative position determination between two UEs, UE A and UE B, which can be used in the performance of a positioning and/or sensing operation, as described above. Here, a first coordinate system 300-A, including axes XA, YA, and ZA, is used by UE A, and a second coordinate system 300-B, including axes XB, YB, and ZB, is used by UE B. Because UE A UE B both have a knowledge of north, both coordinate systems 300-A and 300-B may be aligned (e.g., by aligning the y-axes with north as illustrated. north may be determined by each UE using one or more of a variety of data sources, including sensors (e.g., magnetometers, accelerometers, gyroscopes, cameras, etc.), maps, and the like. The horizontal plane 303-A and 303-B can be determined using the gravitational vector (e.g., with measurements from an accelerometer), and East (aligned with X axes). As such, UE A and UE B may each provide measurements (e.g., positioning and/or sensing measurements) based on the common coordinate systems 300-A and 300-B.

In the example in FIG. 3A, UE A and UE B make measurements indicative of a direction toward the other (e.g., indicated by line 305). These measurements may, for example, be based on AOA and/or AOD measurements of RF signals exchanged between UE A and UE B. (Thus, UE A and UE B each may comprise an antenna array or similar hardware capable of beamforming to perform AOA and/or AOD measurements.) UE A may then send UE B a measurement of elevation 310 and azimuth 320 (as illustrated by a projection 330 of the measured direction to UE B onto the horizontal plane 303-A). Likewise, UE B may send UE A a measurement of elevation 340 and azimuth 350 (as illustrated by a projection 360 of the measured direction to UE A onto the horizontal plane 303-B). As previously noted, UE A and UE B can determine relative location and/or relative velocity using such measurements.

It will be understood that various features illustrated in FIG. 3A are provided as examples, and may vary depending on application. Azimuth angles 320 and 350 are illustrated as being measured clockwise from East (90° clockwise from north and aligned with X axes), but may be measured from north or some other direction and/or may be measured counterclockwise. The specifics of how measurements may be made and communicated may be dictated by a relevant standard or protocol used by UE A and UE B. Sensing and/or positioning measurements may be made of other objects (e.g., other UEs, or sensed objects), in which case azimuth and elevation measurements regarding the other objects may be shared between UE A and UE B.

FIG. 3B illustrates a situation similar to FIG. 3A, in which neither UE A nor UE B has knowledge of north. Features common with FIG. 3A have corresponding labels. Here, UE A and UE B are represented as vehicles. Because UE A and UE B has no knowledge of north (e.g., are unable to determine north based on sensor information or other data), they do not use a coordinate system. Instead, UE A uses a coordinate system 370-A based its orientation (with Y_{A} axis extending forward from the vehicle, and X_{A} axis a 90° angle to the right), UE B uses a coordinate system 370-B based on its orientation (with Y_{B} axis extending forward from the vehicle, and X_{B} axis a 90° angle to the right). Horizontal planes 303-A and 303-B can still be determined based on using the gravitational vector, and thus, elevation measurements 310 and 340 can still be shared between UE A UE B, because they share common reference. However, because X and Y axes are not aligned, azimuth measurements 380 and 390 cannot be communicated between UEs without first establishing a way in which UEs can translate measurements between coordinate systems. It can also be noted that, because UE A and UE B may move over time, Y and X axes for each UE will change over time, thereby further complicating how azimuth angles can be shared between UEs in an intelligible way.

Again, it will be understood that various features illustrated in FIG. 3B are provided as examples, and may vary depending on application. UEs (UE A UE B) may be any of a variety of types of UEs, as previously noted, and UE A may be of a type different than UE B. Further, one or both UEs may be stationary in some scenarios. Additionally or alternatively, one UE may have a knowledge of north in some situations. Moreover, some embodiments may use wireless devices other than UEs.

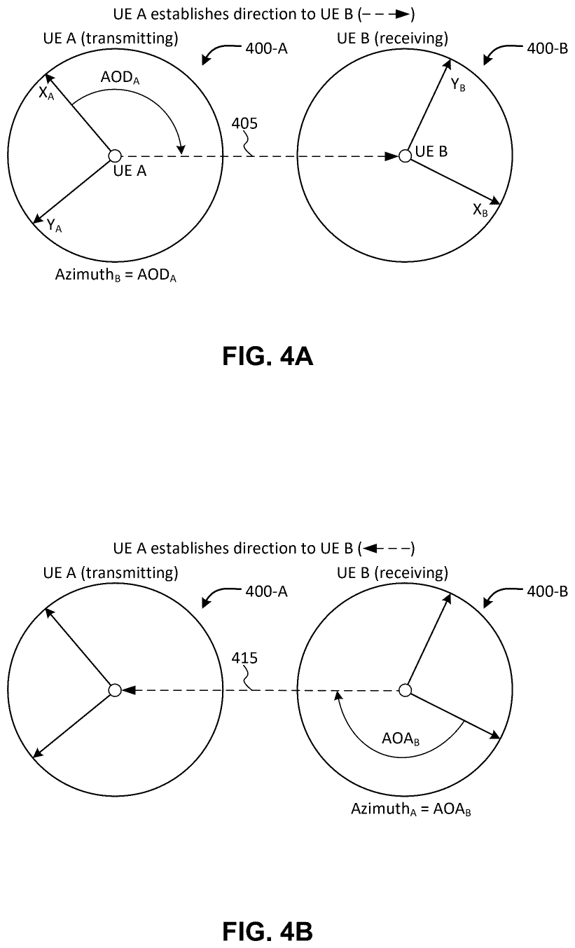

To address scenarios in which a common azimuth reference (e.g., north) is not available to UEs, embodiments provide for the utilization of an azimuth angle based on the direction of an inter-UE directional vector (also referred to herein as a “directional vector,” “inter-UE direction,” “inter-UE vector,” “inter-UE pointing vector,” or “pointing vector”). This vector, which indicates direction from one UE to the other, can be determined by UEs using, for example, AOA and/or AOD measurements. Moreover, this vector can be used as a reference with which azimuth measurements may be shared between UE A and UE B. Details with regard to determining the inter-UE directional vector are provided below, with reference to FIGS. 4A and 4B. (It can be noted that it is the direction of the inter-UE directional vector that is used by embodiments herein; any determined magnitude of the vector may be ignored. In some aspects, therefore, the inter-UE directional vector may be considered a unit or normal vector.)

FIG. 4A illustrates an operation in the determination of an inter-UE directional vector 405 from UE A to UE B, according to an example. It can be noted that communications between UE A and UE B, including coordination of measurements (e.g., AOA and AOD measurements), may be made via sidelink (SL) communications between UE A and UE B, according to some embodiments. Further, the measurements themselves may be made using SL communications, other RF technologies (e.g., Wi-Fi, Bluetooth, ultra-wideband (UWB), etc.), and/or non-RF technologies (e.g., cameras, ultrasound, infrared, lidar, etc.).

Similar to FIG. 3B, each UE has its own coordinate system, where X and Y axes are assigned by the respective UE (again, the Z axes may be determined based on the determination of a horizontal plane from the gravitational vector). The coordinate system 400-A shows the coordinate system of UE A, and the coordinate system 400-B shows the coordinate system of UE B. Again, because UEs may change orientation over time, and because the coordinate systems 400-A and 400-B may be based on the orientation of each respective UE, these coordinate systems 400-A and 400-B may vary with respect to each other over time.

In the operation illustrated in FIG. 4A, UE A determines an azimuth measurement to UE B, Azimuth_{B}, by performing an AOD measurement of an RF signal sent toward UE B. As a person of skill in the art will appreciate, this may involve beamforming, in which UE may transmit outgoing RF signals in different directions (e.g., using different beams). For example, AOD measurements may involve UE B making measurements of these RF signals and providing feedback to UE A (e.g., that indicates which RF signals are received with the most power) to enable UE A to determine the AOD measurement to UE B. The resulting AOD measurement, AOD_{A}, which is made by UE A with respect to its coordinate system 400-A (here, using access X_{A} as a reference axes for the azimuth measurements) is the azimuth measurement to UE B, Azimuth_{B}, which indicates the direction of the inter-UE directional vector 405 as measured by UE A. Again, because coordinate systems 400-A and 400-B may vary with respect to each other over time, the AOD measurement may be made at a given time, T1. Azimuth measurements made at a subsequent time (e.g., T2) may be made in reference to Azimuth_{B} made at time T1.

FIG. 4B illustrates an operation in the determination of an inter-UE directional vector 415 from UE B to UE A, which may be performed in conjunction with the operation illustrated in FIG. 4A. Here, UE B determines an azimuth measurement to UE B, Azimuth_{A} 415, by performing an AOA measurement of an RF signal transmitted by UE A. Again, given the time variance of coordinate systems 400-A and 400-B with respect to each other, the AOA measurement made by UE B may be made at substantially the same time as the AOD measurements made by UE A (e.g., substantially at time T1). And thus, according to some embodiments, the AOA and AOD measurements may utilize the same set of RF signals. Additionally, or alternatively, these measurements may use different RF signals. However, these different RF signals may be transmitted within a threshold amount of time to help minimize the amount of movement between coordinate frames 400-A and 400-B. This threshold amount of time may vary, depending on the type of UEs, the speed of detected or anticipated movement (e.g., rotation) of one or both UEs, and/or other factors. The resulting AOA measurement, AOA_{B}, which is made by UE B with respect to its coordinate system 400-B (here, using access X_{B} as a reference axes for the azimuth measurements) is the azimuth direction to UE A, Azimuth_{A}, which indicates the direction of the inter-UE directional vector from UE B to UE A.

After performing the operations in FIGS. 4A and 4B, UE A and UE B may exchange measured azimuth angles (AOD_{A} and AOA_{B}), which indicate the orientation of coordinate systems 400-A and 400-B with respect to the inter-UE direction. This enables UEs to translate subsequent azimuth measurements between coordinate systems 400-A 400-B. As explained in more detail below, because measured azimuth angles indicate inter-UE direction from the perspective of each respective UE, inter-UE directional vector 405 determined by UE A and inter-UE directional vector determined by UE B 415 are rotated 180°, which can be accounted for in the translation of azimuth angles between coordinate systems 400-A and 400-B.

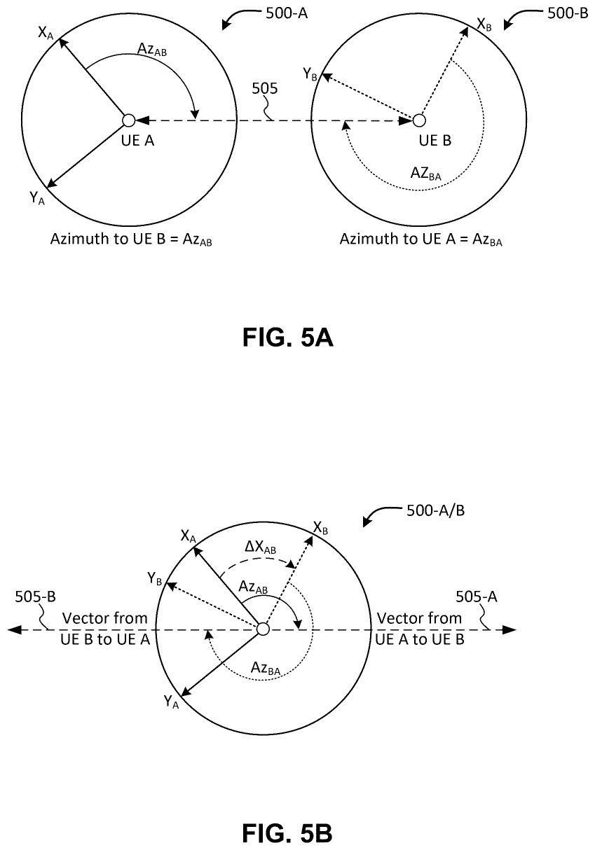

Signaling and/or convention (e.g., as designated by a governing protocol or standard) can establish which UE coordinate axes are used as a reference for any given measurement shared from one UE to the other. For example, in some implementations, UE A may make an azimuth measurement at time T2 (subsequent to the exchange of initial measured azimuth angles), and share that measurement with UE B. UE B can then translate that measurement, made in the coordinate system 400-A of UE A, to its coordinate system 400-B. In some implementations, UE A may make an azimuth measurement at time T2, and share that measurement with UE B, but translate that measurement to the coordinate system 400-B of UE B prior to sending it to UE B. In some implementations, the coordinate system of one UE can be used for all shared measurements. For example, coordinate system 400-A of UE A might be used such that azimuth measurement shared by UE A to UE B will be in coordinate system 400-A, and azimuth measurement shared by UE B to UE A will also be in coordinate system 400-A (and thereby translated from coordinate system 400-B to coordinate system 400-A by UE B prior to transmission to UE A). In this latter case, because only UE B may translate between coordinate systems 400-A and 400-B, UE B may not need to share its initial azimuth measurement (AOA_{B}) with UE A. That said, both UE A and UE B may need to track their own rotational movement subsequent to time T1 to allow translation of measurements made at a time after T1 with reference to the inter-UE directional vector determined at time T1. FIGS. 5A and 5B, described below, help illustrate an example process by which a pair of UEs can determine an inter-UE directional vector and translate subsequently obtained azimuth measurements, according to some embodiments.

FIG. 5A is a diagram of a process by which UEs may determine a common inter-UE directional vector 505 in the coordinate system 500-A of UE A and the coordinate system 500B of UE-B, similar to the process described above with regard to FIGS. 4A and 4B. (The inter-UE directional vector 505 is shown as a double-sided arrow, indicating that the direction could be pointing from UE A to UE B, or vice versa, depending on which UE's perspective the directional vector is meant to represent, as indicated above.) As with other figures herein, FIG. 5A is meant to be a non-limiting example. The relative orientation of coordinate systems 500-A and 500-B with respect to each other will vary on the situation and, as previously mentioned, may depend on the particular rotation of UE A and UE B when the process illustrated in FIG. 5A occurs. The initiation of the process of determining the common inter-UE directional vector 505 may be triggered by a determination, by one or both UEs, that the UEs do not share a common coordinate system or reference direction. This may be determined, for example, during a RF positioning and/or RF sensing session during which UEs exchange capability and other information related to the session.

According to some embodiments of the process of determining the common inter-UE directional vector 505, UE A and UE B initially may independently assign respective reference axes (X_{A}, Y_{A}), (X_{B}, Y_{B}) in the horizontal plane. As previously noted, this assignment may be fixed relative to the orientation of the UE, according to some embodiments. That said, other embodiments may assign these axes based on other factors, which, in some cases, may be defined and/or determined in accordance with a relevant standard and/or protocol.

Once axes are established, UE A may determine a vector direction to UE B (e.g., via sidelink positioning), which may involve an AOD and/or AOA measurement of an RF signal transmitted by and/or received from UE B, as previously indicated. To do so, UE A may measure the azimuth angle to UE B, AZ_{AB}, in UE A's local coordinate system. As illustrated AZ_{AB} may be measured from UE A's self-assigned XA-axis to the vector pointing to UE B. (That said, as previously mentioned, different conventions for measuring the azimuth angle may be used, depending on desired functionality.)

Similarly, UE B may determine a vector direction to UE A (e.g., via sidelink positioning). To do so, UE B may measure the azimuth angle to UE B, AZ_{BA}, in UE B's local coordinate system (again, which may involve making an AOA and/or AOD measurement). To help ensure the inter-UE directional vector 505 is common between UE A and UE B, UE B may determine the vector direction to UE A simultaneously or at substantially the same time as when UE A determines a vector direction to UE A. This can help ensure that the relative orientation of coordinate systems 500-A and 500-B is substantially the same when azimuth angles AZ_{AB} and AZ_{BA} are measured, which helps ensure the inter-UE directional vector measured from UE A to UE B is substantially rotated 180° from the inter-UE directional vector measured from UE B to UE A, increasing the accuracy of translations between coordinate systems 500-A and 500-B.

Once measurements AZ_{AB} and AZ_{BA} are taken, UE B and UE A may exchange these measurements, along with the respective times at which these measurements were taken. Thus, UE A can send its measurement and measurement time (AZ_{AB}, tA_{z_AB}) to UE B, and UE B can send its measurement and measurement time (AZ_{BA}, tA_{z_BA}) to UE B. As previously noted, this exchange of measurement information between UEs can take place via an application layer and/or lower-layer signaling. The layer at which the signaling takes place may be based on which application or function is coordinating the position between UEs.

Subsequent to the exchange of angle information, both UEs have a common reference, common inter-UE directional vector 505, and can translate between respective axes. Details are provided below, with respect to FIG. 5B.

FIG. 5B is a graph illustrating combined coordinate systems 500-A/B, which represents coordinate system 500-A of UE A and coordinate system 500-B of UE B overlaid on each other, provided to help illustrate how translation may occur between coordinate systems 500-A and 500-B. Similar to FIG. 5A, the axes (X_{A}, Y_{A}) and measured azimuth angle to UE B (AZ_{AB}) made by UE A are shown with solid lines, and the axes (X_{B}, Y_{B}) and measured azimuth angle to UE A (AZ_{BA}) made by UE B are shown with dotted lines. The double-sided inter-UE directional vector 505 of FIG. 5A has also been split into a vector 505-A from UE A to UE B, and a vector 505-B from UE B to UE A.

In particular, the angular difference between X_{A} and X_{B} axes, ΔX_{AB}, can be computed as follows:

$$Δ {X}_{AB} = ( {Az}_{AB} - {Az}_{BA} ) + 180 ° . \qquad ( Eqn . 1 )$$

Once computed, this angular difference, ΔX_{AB}, can be used by UEs to translate azimuth angles between coordinate frames 500-A and 500-B that may be measured by UE A and/or UE B and exchanged in subsequent RF positioning and/or RF sensing transactions. This can include, for example, the exchange of azimuth measurements to determine position and/or relative velocity of the UEs.

The translation between coordinate frames 500-A and/or 500-B may be performed in accordance with an agreement between the UEs at an application or lower layer, or may be based on a convention, standard, and/or protocol. Translations may include, for example:
A. Translating azimuth measurements to coordinate frame 500-A. For example, UE B translates azimuth measurements to coordinate frame 500-A, before sending the azimuth measurements to UE A. UE A, on the other hand, keeps azimuth measurements in coordinate frame 500-A (without translation) when sending them to UE B.
B. Translating azimuth measurements to coordinate frame 500-B. For example, UE A translates azimuth measurements to coordinate frame 500-B, before sending the azimuth measurements to UE B. UE B, on the other hand, keeps azimuth measurements in coordinate frame 500-B (without translation) when sending them to UE A.
C. Translating azimuth measurements by a sending UE to the coordinate frame of a receiving UE, before sending the azimuth measurements to the receiving UE. For example, UE A translates azimuth measurements to coordinate frame 500-B, before sending the azimuth measurements to UE B. Additionally, UE B translates azimuth measurements to coordinate frame 500-A, before sending the azimuth measurements to UE A.
D. Translating azimuth measurements by a receiving UE to the coordinate frame of the receiving UE, after receiving the azimuth measurements from a sending UE. For example, UE A translates azimuth measurements to coordinate frame 500-A, after receiving the azimuth measurements from UE B. Additionally, UE B translates azimuth measurements to coordinate frame 500-B, after receiving the azimuth measurements from UE B.

Whichever scheme is used, translations may continue in accordance with the scheme for the duration of a positioning and/or sensing session between the UEs, for an agreed-upon duration, or for another duration as determined or defined in a relevant protocol or standard used by the UEs.

Equation 1 above can be used as a basis to translate between coordinate frames, regardless of the relative rotation between UE A and UE B. For example, in the example of FIGS. 5A and 5B, in which 180°>AZ_{AB}>90° and 270°>AZ_{BA}>180°, equation 1 can be rewritten so that AZ_{BA} can be found as follows:

$$( {Az}_{AB} - Δ {X}_{AB} ) + 180 ° = {Az}_{BA} . \qquad ( Eqn . 2 )$$

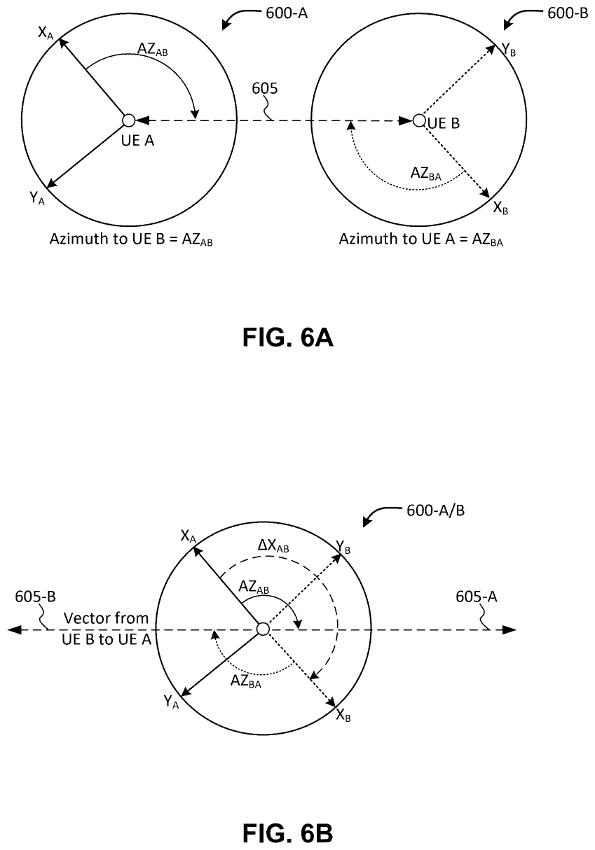

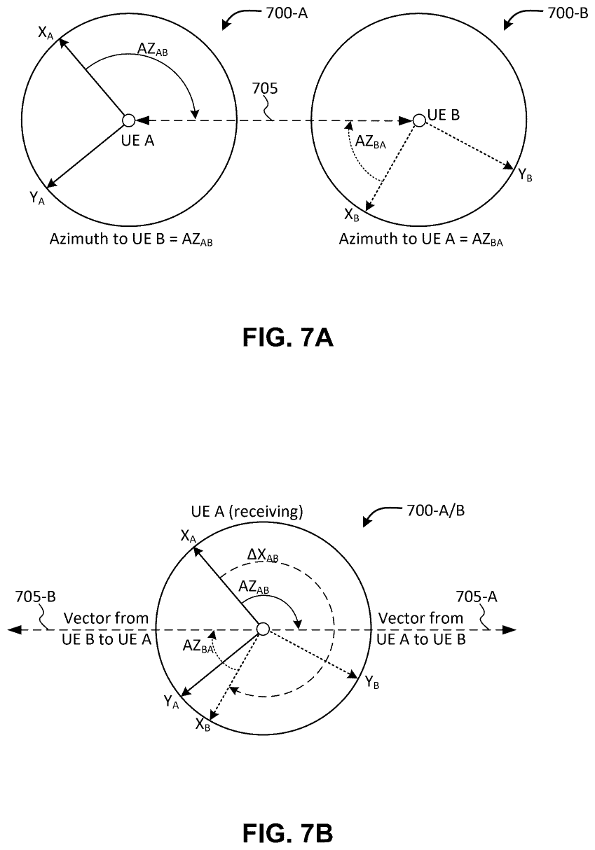

This translation of Eqn. 2 holds under other conditions, as illustrated in FIGS. 6A-7B, described below.

FIGS. 6A and 6B are diagrams, similar to FIGS. 5A and 5B, showing coordinate frames 600-A and 600-B (and combined coordinate frame 600-A/B) of another pair of UEs. Here, a common inter-UE directional vector 605 is established in a situation in which 180°>AZ_{AB}>90° and 180°>AZ_{BA}>90°. Again, Eqn. 2 can be used to translate between coordinate frames 600-A and 600-B.

FIGS. 7A and 7B are diagrams, similar to FIGS. 5A and 5B and FIGS. 6A and 6B, showing coordinate frames 700-A and 700-B (and combined coordinate frame 700-A/B) of yet another pair of UEs. Here, a common inter-UE directional vector 605 is established in a situation in which 180°>AZ_{AB}>90° and 90°>AZ_{BA}>0°. Again, Eqn. 2 can be used to translate between coordinate frames 700-A and 700-B.

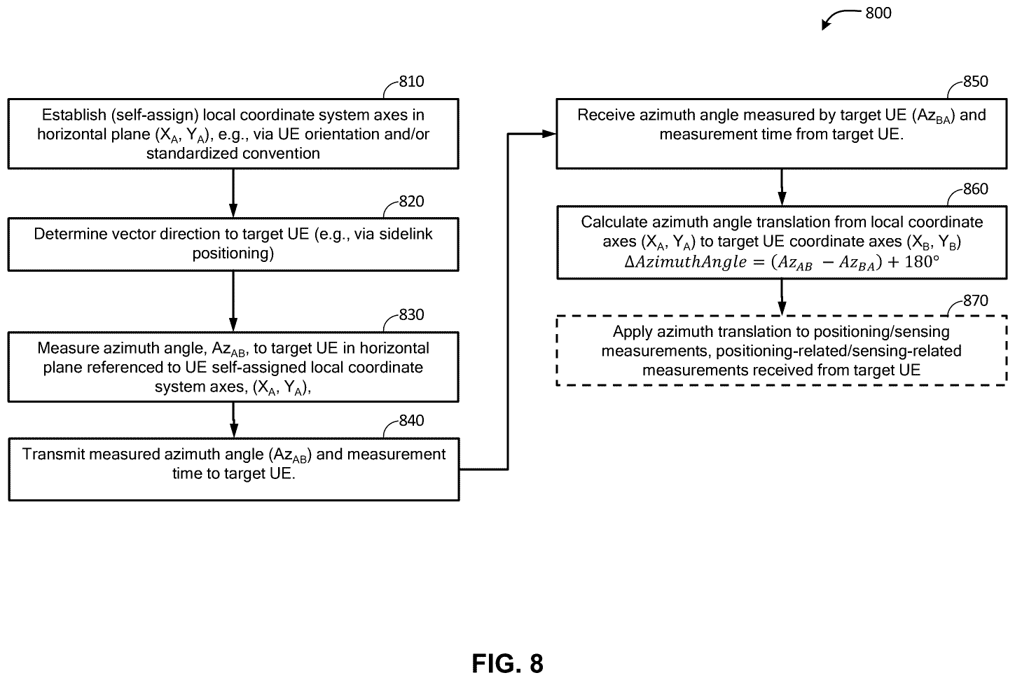

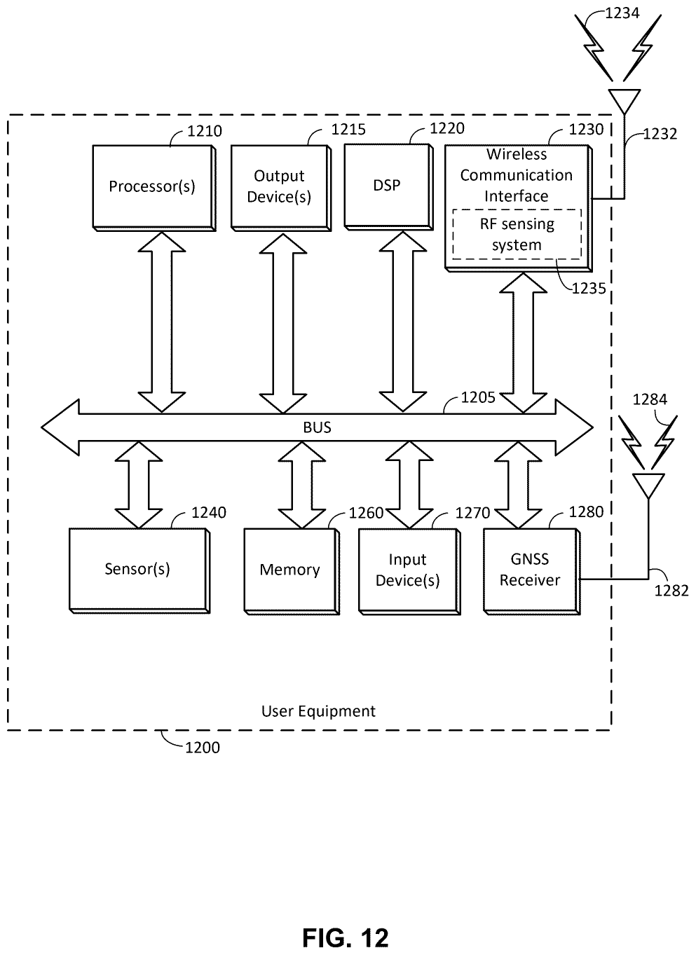

FIG. 8 is a flow diagram of a process 800 that a UE may perform to establish an inter-UE directional vector with a target UE, as a reference for azimuth measurements, according to some embodiments. The method 800 may be performed by the UE (e.g., mobile device, vehicle, etc.), and examples hardware and software components of a UE capable of performing the method 800 are illustrated in FIG. 12, described below. A person of ordinary skill in the art will appreciate that alternative embodiments may add, omit, separate, or otherwise rearrange many of the functions illustrated in FIG. 8, while providing the same or similar overall functionality. The process 800 may reflect various aspects previously described, in which the UE performing the process corresponds with UE A, and the target UE corresponds with UE B, as described in other embodiments described herein.

The process 800 may begin with the operation that block 810, in which the UE can establish (or self-assign) axes in the horizontal plane of a local coordinate system. This can be done as described previously, by determining a horizontal plane (which may be determined using the gravitational vector) and assigning axes accordingly. As previously noted, the axes may be assigned in accordance with the orientation of the UE and/or an applicable standardized convention.

The operation at block 820 comprises determining a vector direction to a target UE. This vector direction may correspond with the inter-UE directional vector described elsewhere herein. As noted elsewhere, this can be done using AOA and/or AOD measurements, which may be performed using a sidelink (SL) connection with the target UE. As such, it may be performed as part of a sidelink positioning or communication session. Additionally, or alternatively, a vector direction may be performed using other types of measurements and/or other technologies. As previously noted, this may include other RF technologies (e.g., Wi-Fi, Bluetooth, ultra-wideband (UWB), etc.), and/or non-RF technologies (e.g., cameras, ultrasound, infrared, lidar, etc.).

The operation at block 830 comprises measuring an azimuth angle, Az_{AB}, in the horizontal plane of the UE using the self-assigned local coordinate axes of the UE. As discussed in the above-described embodiments, this measurement may be a measurement between the x-axis of the UE and the inter-UE directional vector determined at block 820. (That said, other inventions may be used, depending on desired functionality.) Once this azimuth angle is measured, the UE can then transmit the measured azimuth angle and the time measurement (time at which the measured azimuth angle was taken) to the target UE, as described above and indicated at block 840.

The operations at block 850 and 860 further indicate how the UE can process a similar incoming azimuth angle measured from the target UE. At block 850, for example, the functionality comprises receiving the azimuth angle measurement, Az_{BA}, from the target UE (in which the azimuth angle measurement Az_{BA} represents an angle between the inter-UE directional vector and axis (e.g., x-axis) of the local coordinate system used by the target UE). At block 860, the UE can then calculate the translation between the local coordinates of the UE and the local coordinates of the target UE. (Note that the equation in block 860 corresponds to Eqn. 1, as described above.)

With the ability to translate between coordinate systems, the UE can then apply azimuth translation to positioning measurements, sensing measurements, positioning-related measurements, sensing-related measurements, or any combination thereof, received from the target UE. Additionally, or alternatively, the UE can adhere to an applicable translation scheme (e.g., any of translation schemes A-D described above).

As previously noted, the communication between UEs and the embodiments provided herein (e.g., UE and target UE, UE A and UE B) may be performed at an application layer or a lower layer. Example lower layers include Sidelink Positioning Protocol (SLPP), Radio Resource Control (RRC), PC5-RRC, PC5-S, or the like. Application-layer signaling may be done in accordance with an applicable standard, which may be established by standards development organizations (SDOs) such as Society of Automotive Engineers (SAE), European Telecommunications Standards Institute (ETSI), China Communications Standards Association (CCSA)/Chinese Society of Automotive Engineers (CSAE), or the like.

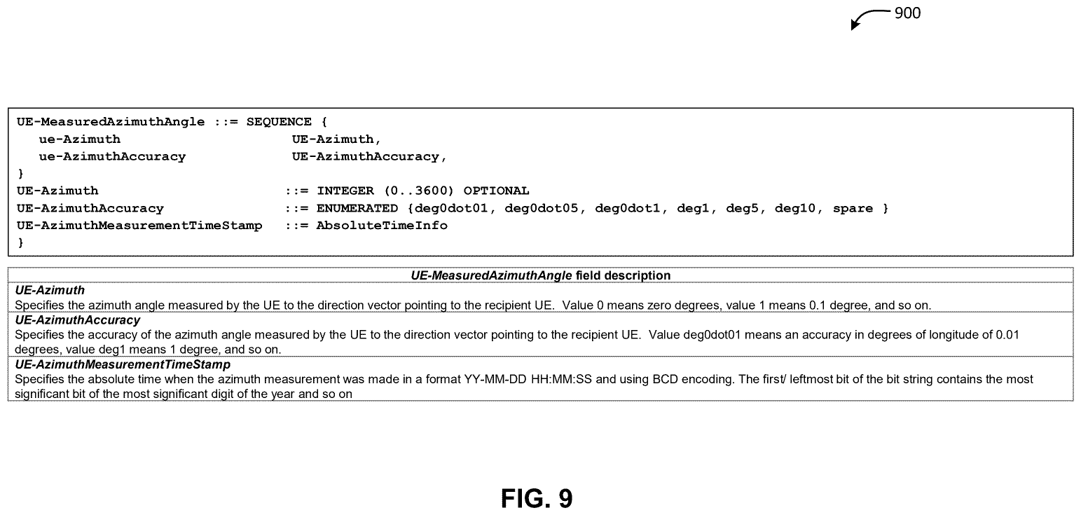

FIG. 9 is an illustration of example portions 900 of an applicable standard that define an information element (IE) for communicating information as described herein for determining an inter-UE directional vector between to UEs, as described herein. In this example, IE UE-MeasuredAzimuthAngle can include various components such as UE-Azimuth and UE-AzimuthMeasurementTimeStamp, which can relay information regarding the measured UE azimuth angle and measurement time, as described above. Additionally, according to this example, UE-AzimuthAccuracy may be relayed, which may be indicative of an accuracy of the azimuth angle measurement, as described in FIG. 9. This accuracy measurement may be taken into account when determining an accuracy of a positioning and/or sensing measurement that uses an azimuth measurement that has been translated from the coordinate system of one UE to the coordinate system of the other. Alternative embodiments may include additional or alternative components.

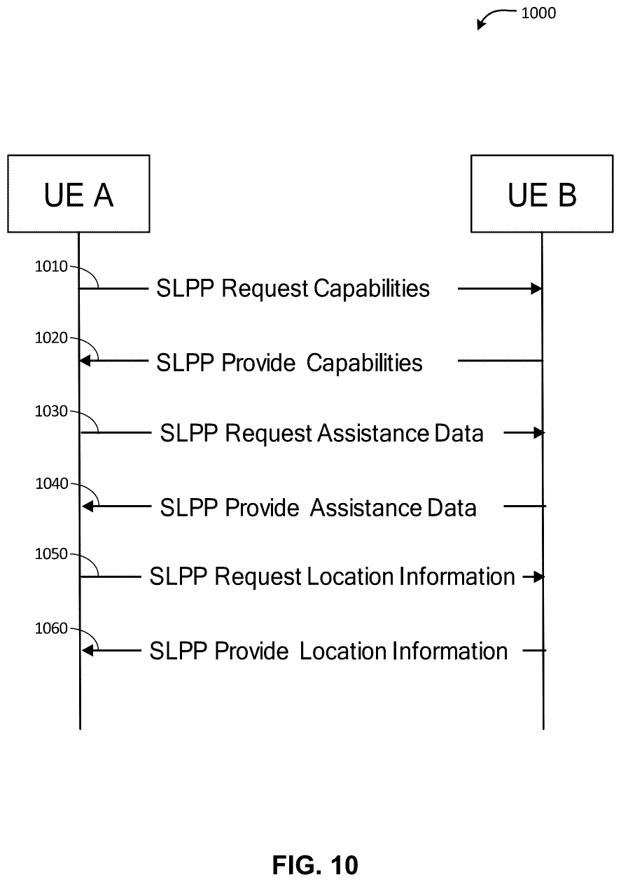

FIG. 10 is a call flow diagram illustrating an example information exchange 1000 between UE A and UE B, in accordance with SLPP, as defined in the 3GPP TS 38.355 standard. The information exchange 1000 is provided as an example of a positioning-related information exchange between UEs that could be modified to include the information used to establish and use an inter-UE directional vector as described in the embodiments herein. The information exchange 1000 could use, for example, the example IE illustrated in FIG. 9 to exchange measured azimuth information.

To implement the functionality described in the embodiments herein, the SLPP information exchange 1000 could be modified in various ways, depending on desired functionality. According to some embodiments, for example, the capabilities exchange (shown with arrows 1010 and 1020) could include an IE to indicate that a UE (UE A or UE B) does not have knowledge of north (or is otherwise incapable of providing measurements in a common coordinates system). This could be a simple Boolean variable, for example, to indicate that the UE does or does not have knowledge of north. In the assistance data exchange, shown with arrows 1030 and 1040, messages provided by UEs could incorporate additional information elements to express the azimuthal information (e.g., an azimuth measurement, timestamp, and optional accuracy, as indicated in FIG. 9). Additionally, or alternatively, a new, dedicated SLPP message could be defined to express the azimuthal information. Subsequently provided information, such as the Request and Provide Location Information messages exchanged by the UEs (shown with arrows 1050 and 1060), may include azimuth measurements that may be translated by the sending or receiving UE, pursuant to the applicable translation scheme adopted by UE A and UE B.

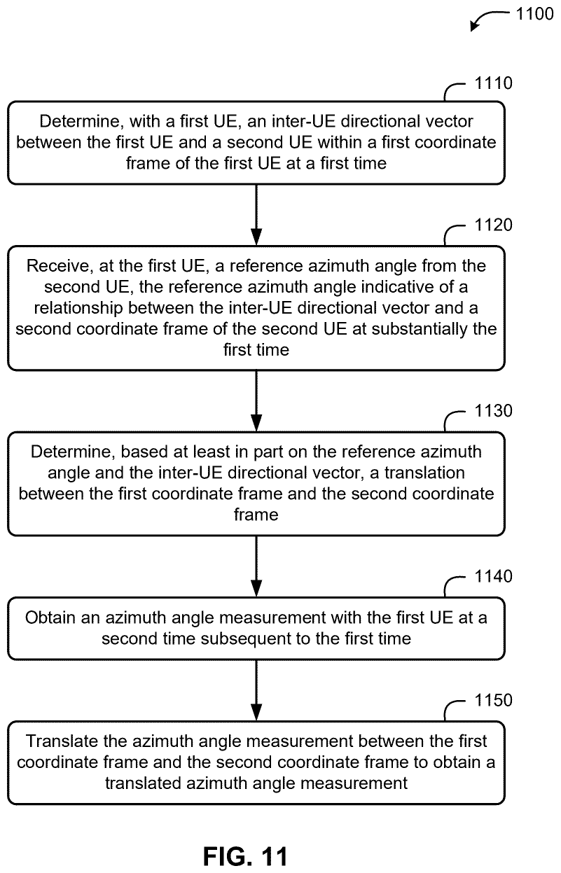

FIG. 11 is a flow diagram of a method 1100 of determining a common azimuth angle between UEs, according to an embodiment. Means for performing the functionality illustrated in one or more of the blocks shown in FIG. 11 may be performed by hardware and/or software components of a UE. Example components of a UE are illustrated in FIG. 12, which is described in more detail below. As noted elsewhere herein, a UE may comprise any of a variety of different types of devices, including, for example, a mobile phone or vehicle.

At block 1110, the functionality comprises determining, with a first UE, an inter-UE directional vector between the first UE and a second UE within a first coordinate frame of the first UE at a first time. As described in the embodiments above, this determination may be made using angular measurements of RF signals exchanged between UEs and/or information from other sensors, such as cameras, lidar, etc. Thus, according to some embodiments of the method 1100, determining the inter-UE directional vector between the first UE and the second UE is based on an angle of departure (AOD) measurement of an RF signal sent from the first UE to the second UE, an angle of arrival measurement (AOA) of an RF signal sent from the second UE to the first UE, a camera or lidar image of the second UE captured by the first UE, a sound measurement of the second UE captured by the first UE, or any combination thereof.

Means for performing functionality at block 1110 may comprise one or more processors 1210, a digital signal processor (DSP) 1220, a wireless communication interface 1230 (which may include an RF sensing system 1235), one or more sensors 1240, a memory 1260, a GNSS receiver 1280, and/or other components of a UE, as illustrated in FIG. 12.

At block 1120, the functionality comprises receiving, at the first UE, a reference azimuth angle from the second UE, the azimuth angle indicative of a relationship between the inter-UE directional vector and a second coordinate frame of the second UE at substantially the first time. As described in the embodiments above and shown in the examples of FIGS. 4A-8, this azimuth angle may be made by the second UE using a measurement similar to the measurement made by the first UE at block 1110. According to some embodiments, the first UE may be in direct wireless communications (e.g., D2D) with the second UE. And thus, according to some embodiments, receiving the reference azimuth angle comprises receiving the reference azimuth angle via Sidelink Positioning Protocol (SLPP), Radio Resource Control (RRC), PC5-RRC, application layer signaling, or any combination thereof.

Means for performing functionality at block 1120 may comprise one or more processors 1210, a DSP 1220, a wireless communication interface 1230 (which may include an RF sensing system 1235, a memory 1260, a GNSS receiver 1280, and/or other components of a UE, as illustrated in FIG. 12.

At block 1130, the functionality comprises determining, based at least in part on the reference azimuth angle and the inter-UE directional vector, a translation between the first coordinate frame and the second coordinate frame. As noted in the embodiments herein, a difference between the inter-UE directional vector (in the coordinate system of the first UE) with the reference azimuth angle can reflect the rotational difference between the first and second coordinate frames. As also indicated herein (e.g., in the process 800 of FIG. 8), a translation may also account for a 180° difference in azimuth angles between inter-UE directional vectors at each UE. As also indicated herein, rotation subsequent to the first time may be tracked (e.g., by either/both UEs) and accounted for when applying the translation to subsequent azimuth measurements.

Means for performing functionality at block 1130 may comprise one or more processors 1210, a digital signal processor (DSP) 1220, a wireless communication interface 1230 (which may include an RF sensing system 1235), one or more sensors 1240, a memory 1260, a GNSS receiver 1280, and/or other components of a UE, as illustrated in FIG. 12.

At block 1140, the functionality comprises obtaining an azimuth angle measurement with the first UE at a second time subsequent to the first time. Further, at block 1150, the functionality comprises translating the azimuth angle measurement between the first coordinate frame and the second coordinate frame to obtain a translated azimuth angle measurement. The functionality at these blocks may vary, depending on how the azimuth angle measurement is obtained and what convention is used between the two UEs. As noted in the embodiments herein, one UE may translate an incoming azimuth measurement from another UE and/or translate a measurement before sending it to the other UE.

When applied to the method 1100, these variations may be understood in different ways. As a first example, in some instances of the method 1100, obtaining the azimuth angle measurement with the first UE comprises performing the azimuth angle measurement with the first UE and translating the azimuth angle measurement between the first coordinate frame and the second coordinate frame comprises translating the azimuth angle measurement from the first coordinate frame to the second coordinate frame. In such instances, the method 1100 may further comprise sending the translated azimuth angle measurement from the first UE to the second UE. Moreover, in such instances, the azimuth angle measurement is performed with the first UE as part of a positioning or sensing operation. As a second example, in some instances of the method 1100, obtaining the azimuth angle measurement with the first UE comprises receiving the azimuth angle measurement at the first UE from the second UE and translating the azimuth angle measurement between the first coordinate frame and the second coordinate frame comprises translating the azimuth angle measurement from the second coordinate frame to the first coordinate frame. In such instances, the method may further comprise performing a positioning or sensing operation at the first UE using the translated azimuth angle measurement.

Means for performing functionality at block 1150 may comprise one or more processors 1210, a digital signal processor (DSP) 1220, a wireless communication interface 1230 (which may include an RF sensing system 1235), one or more sensors 1240, a memory 1260, a GNSS receiver 1280, and/or other components of a UE, as illustrated in FIG. 12.

As noted herein, embodiments may include additional features, depending on desired functionality. For example, according to some embodiments, both UEs may exchange their respective reference azimuth angles, enabling both UEs two translate between first and second coordinate frames. Thus, some embodiments of the method 1100 may further include determining, at the first UE, a second reference azimuth angle indicative of a relationship between the inter-UE directional vector and the first coordinate frame of the first UE at the first time and sending the second reference azimuth angle from the first UE to the second UE. In such embodiments, the second reference azimuth angle may comprise an angle between a fixed axis relative to a body of the first UE and the inter-UE directional vector.

FIG. 12 is a block diagram of an embodiment of a user equipment 1200, which can be utilized as described herein. For example, user equipment 1200 may correspond to a mobile device (e.g., mobile device 105 of FIG. 1), UE (e.g., UE 205 of FIG. 2, UE A or UE B of FIGS. 4A-7B and 10, UE or target UE of FIG. 8, or first or second UE of FIG. 11), or the like, as described herein. As such, the user equipment 1200 may be capable of performing some or all of the functionality described in the methods regarding UEs described herein, including the method of FIG. 11. It should be noted that FIG. 12 is meant only to provide a generalized illustration of various components, any or all of which may be utilized as appropriate.

The user equipment 1200 is shown comprising hardware elements that can be electrically coupled via a bus 1205 (or may otherwise be in communication, as appropriate). The hardware elements may include a processor(s) 1210 which can include without limitation one or more general-purpose processors (e.g., an application processor), one or more special-purpose processors (such as digital signal processor (DSP) chips, graphics acceleration processors, application specific integrated circuits (ASICs), and/or the like), and/or other processing structures or means. Processor(s) 1210 may comprise one or more processing units, which may be housed in a single integrated circuit (IC) or multiple ICs. As shown in FIG. 12, some embodiments may have a separate DSP 1220, depending on desired functionality. Location determination and/or other determinations based on wireless communication may be provided in the processor(s) 1210 and/or wireless communication interface 1230 (discussed below). The user equipment 1200 also can include one or more input devices 1270, which can include without limitation one or more keyboards, touch screens, touch pads, microphones, buttons, dials, switches, and/or the like; and one or more output devices 1215, which can include without limitation one or more displays (e.g., touch screens), light emitting diodes (LEDs), speakers, and/or the like.

The user equipment 1200 may also include a wireless communication interface 1230, which may comprise without limitation a modem, a network card, an infrared communication device, a wireless communication device, and/or a chipset (such as a Bluetooth® device, an IEEE 802.11 device, an IEEE 802.15.4 device, a Wi-Fi device, a WiMAX device, a WAN device, and/or various cellular devices, etc.), and/or the like, which may enable the user equipment 1200 to communicate and/or perform positioning with other devices as described in the embodiments above, with respect to WLAN and/or cellular technologies. The wireless communication interface 1230 may permit data and signaling to be communicated (e.g., transmitted and received) with NG-RAN nodes of a network, for example, via cNBs, gNBs, ng-eNBs, access points, NTN satellites, various base stations, TRPs, and/or other access node types, and/or other network components, computer systems, and/or any other electronic devices communicatively coupled with TRPs, as described herein. The communication can be carried out via one or more wireless communication antenna(s) 1232 that send and/or receive wireless signals 1234. According to some embodiments, the wireless communication antenna(s) 1232 may comprise a plurality of discrete antennas, antenna arrays, or any combination thereof. The antenna(s) 1232 may be capable of transmitting and receiving wireless signals using beams (e.g., Tx beams and Rx beams). Beam formation may be performed using digital and/or analog beam formation techniques, with respective digital and/or analog circuitry. The wireless communication interface 1230 may include such circuitry.

As noted herein, the user equipment 1200 may be capable of performing RF sensing. Thus, the UE 1200 optionally (as indicated by dashed lines) may include an RF sensing system 1235, which may comprise the hardware and/or software elements capable of transmitting, receiving, and processing RF signals for RF sensing. As illustrated in FIG. 12, some or all of the RF sensing system 1235 may be implemented within a wireless communication interface 1230, which may utilize certain components for both communication and RF sensing. That said, embodiments are not so limited. Alternative embodiments may implement some or all of the RF sensing system 1235 separate from the wireless communication interface 1230 (e.g., in cases where RF sensing may utilize different frequencies and/or different hardware/software components than the wireless communication interface 1230).

Depending on desired functionality, the wireless communication interface 1230 may comprise a separate receiver and transmitter, or any combination of transceivers, transmitters, and/or receivers to communicate with base stations (e.g., ng-eNBs and gNBs) and other terrestrial transceivers, such as wireless devices and access points, as well as NTN satellites. The user equipment 1200 may communicate with different data networks that may comprise various network types. For example, a WWAN may be a CDMA network, a Time Division Multiple Access (TDMA) network, a Frequency Division Multiple Access (FDMA) network, an Orthogonal Frequency Division Multiple Access (OFDMA) network, a Single-Carrier Frequency Division Multiple Access (SC-FDMA) network, a WiMAX (IEEE 802.16) network, and so on. A CDMA network may implement one or more RATs such as CDMA2000®, WCDMA, and so on. CDMA2000® includes IS-95, IS-2000 and/or IS-856 standards. A TDMA network may implement GSM, Digital Advanced Mobile Phone System (D-AMPS), or some other RAT. An OFDMA network may employ LTE, LTE Advanced, 5G NR, and so on. 5G NR, LTE, LTE Advanced, GSM, and WCDMA are described in documents from 3GPP. CDMA2000® is described in documents from a consortium named “3rd Generation Partnership Project 2” (3GPP2). 3GPP and 3GPP2 documents are publicly available. A wireless local area network (WLAN) may also be an IEEE 802.11x network, and a wireless personal area network (WPAN) may be a Bluetooth network, an IEEE 802.15x, or some other type of network. The techniques described herein may also be used for any combination of WWAN, WLAN and/or WPAN.

The user equipment 1200 can further include sensor(s) 1240. Sensor(s) 1240 may comprise, without limitation, one or more inertial sensors and/or other sensors (e.g., accelerometer(s), gyroscope(s), camera(s), magnetometer(s), altimeter(s), microphone(s), proximity sensor(s), light sensor(s), barometer(s), and the like), some of which may be used to obtain position and/or RF sensing measurements and/or other information. Further sensor(s) 1240 may include cameras, ultrasound devices, infrared transmitters/receivers, lidar equipment, etc.) capable of determining a direction to another UE, as described herein.

Embodiments of the user equipment 1200 may also include a Global Navigation Satellite System (GNSS) receiver 1280 capable of receiving signals 1284 from one or more GNSS satellites using an antenna 1282 (which could be the same as antenna 1232). Positioning based on GNSS signal measurement can be utilized to complement and/or incorporate the techniques described herein. The GNSS receiver 1280 can extract a position of the user equipment 1200, using conventional techniques, from GNSS satellites of a GNSS system, such as Global Positioning System (GPS), Galileo, GLONASS, Quasi-Zenith Satellite System (QZSS) over Japan, IRNSS over India, BeiDou Navigation Satellite System (BDS), and/or the like. Moreover, the GNSS receiver 1280 can be used with various augmentation systems (e.g., a Satellite Based Augmentation System (SBAS)) that may be associated with or otherwise enabled for use with one or more global and/or regional navigation satellite systems, such as, e.g., Wide Arca Augmentation System (WAAS), European Geostationary Navigation Overlay Service (EGNOS), Multi-functional Satellite Augmentation System (MSAS), and Geo Augmented Navigation system (GAGAN), and/or the like.

It can be noted that, although GNSS receiver 1280 is illustrated in FIG. 12 as a distinct component, embodiments are not so limited. As used herein, the term “GNSS receiver” may comprise hardware and/or software components configured to obtain GNSS measurements (measurements from GNSS satellites). In some embodiments, therefore, the GNSS receiver may comprise a measurement engine executed (as software) by one or more processors, such as processor(s) 1210, DSP 1220, and/or a processor within the wireless communication interface 1230 (e.g., in a modem). A GNSS receiver may optionally also include a positioning engine, which can use GNSS measurements from the measurement engine to determine a position of the GNSS receiver using an Extended Kalman Filter (EKF), Weighted Least Squares (WLS), particle filter, or the like. The positioning engine may also be executed by one or more processors, such as processor(s) 1210 or DSP 1220.

The user equipment 1200 may further include and/or be in communication with a memory 1260. The memory 1260 can include, without limitation, local and/or network accessible storage, a disk drive, a drive array, an optical storage device, a solid-state storage device, such as a random-access memory (RAM), and/or a read-only memory (ROM), which can be programmable, flash-updateable, and/or the like. Such storage devices may be configured to implement any appropriate data stores, including without limitation, various file systems, database structures, and/or the like.

The memory 1260 of the user equipment 1200 also can comprise software elements (not shown in FIG. 12), including an operating system, device drivers, executable libraries, and/or other code, such as one or more application programs, which may comprise computer programs provided by various embodiments, and/or may be designed to implement methods, and/or configure systems, provided by other embodiments, as described herein. Merely by way of example, one or more procedures described with respect to the method(s) discussed above may be implemented as code and/or instructions in memory 1260 that are executable by the user equipment 1200 (and/or processor(s) 1210 or DSP 1220 within user equipment 1200). In some embodiments, then, such code and/or instructions can be used to configure and/or adapt a general-purpose computer (or other device) to perform one or more operations in accordance with the described methods.

It will be apparent to those skilled in the art that substantial variations may be made in accordance with specific requirements. For example, customized hardware might also be used and/or particular elements might be implemented in hardware, software (including portable software, such as applets, etc.), or both. Further, connection to other computing devices such as network input/output devices may be employed.

With reference to the appended figures, components that can include memory can include non-transitory machine-readable media. The term “machine-readable medium” and “computer-readable medium” as used herein, refer to any storage medium that participates in providing data that causes a machine to operate in a specific fashion. In embodiments provided hereinabove, various machine-readable media might be involved in providing instructions/code to processors and/or other device(s) for execution. Additionally or alternatively, the machine-readable media might be used to store and/or carry such instructions/code. In many implementations, a computer-readable medium is a physical and/or tangible storage medium. Such a medium may take many forms, including but not limited to, non-volatile media and volatile media. Common forms of computer-readable media include, for example, magnetic and/or optical media, any other physical medium with patterns of holes, a RAM, a programmable ROM (PROM), erasable PROM (EPROM), a FLASH-EPROM, any other memory chip or cartridge, or any other medium from which a computer can read instructions and/or code.

The methods, systems, and devices discussed herein are examples. Various embodiments may omit, substitute, or add various procedures or components as appropriate. For instance, features described with respect to certain embodiments may be combined in various other embodiments. Different aspects and elements of the embodiments may be combined in a similar manner. The various components of the figures provided herein can be embodied in hardware and/or software. Also, technology evolves and, thus many of the elements are examples that do not limit the scope of the disclosure to those specific examples.

It has proven convenient at times, principally for reasons of common usage, to refer to such signals as bits, information, values, elements, symbols, characters, variables, terms, numbers, numerals, or the like. It should be understood, however, that all of these or similar terms are to be associated with appropriate physical quantities and are merely convenient labels. Unless specifically stated otherwise, as is apparent from the discussion above, it is appreciated that throughout this Specification discussion utilizing terms such as “processing,” “computing,” “calculating,” “determining,” “ascertaining,” “identifying,” “associating,” “measuring,” “performing,” or the like refer to actions or processes of a specific apparatus, such as a special purpose computer or a similar special purpose electronic computing device. In the context of this Specification, therefore, a special purpose computer or a similar special purpose electronic computing device is capable of manipulating or transforming signals, typically represented as physical electronic, electrical, or magnetic quantities within memories, registers, or other information storage devices, transmission devices, or display devices of the special purpose computer or similar special purpose electronic computing device.

Terms, “and” and “or” as used herein, may include a variety of meanings that also is expected to depend, at least in part, upon the context in which such terms are used. Typically, “or” if used to associate a list, such as A, B, or C, is intended to mean A, B, and C, here used in the inclusive sense, as well as A, B, or C, here used in the exclusive sense. In addition, the term “one or more” as used herein may be used to describe any feature, structure, or characteristic in the singular or may be used to describe some combination of features, structures, or characteristics. However, it should be noted that this is merely an illustrative example and claimed subject matter is not limited to this example. Furthermore, the term “at least one of” if used to associate a list, such as A, B, or C, can be interpreted to mean any combination of A, B, and/or C, such as A, AB, AA, AAB, AABBCCC, etc.

Having described several embodiments, various modifications, alternative constructions, and equivalents may be used without departing from the scope of the disclosure. For example, the above elements may merely be a component of a larger system, wherein other rules may take precedence over or otherwise modify the application of the various embodiments. Also, a number of steps may be undertaken before, during, or after the above elements are considered. Accordingly, the above description does not limit the scope of the disclosure.

In view of this description, embodiments may include different combinations of features. Implementation examples are described in the following numbered clauses:

Clause 1: A method of determining a common azimuth angle between user equipments (UEs), the method comprising: determining, with a first UE, an inter-UE directional vector between the first UE and a second UE within a first coordinate frame of the first UE at a first time; receiving, at the first UE, a reference azimuth angle from the second UE, the reference azimuth angle indicative of a relationship between the inter-UE directional vector and a second coordinate frame of the second UE at substantially the first time; determining, based at least in part on the reference azimuth angle and the inter-UE directional vector, a translation between the first coordinate frame and the second coordinate frame; obtaining an azimuth angle measurement with the first UE at a second time subsequent to the first time; and translating the azimuth angle measurement between the first coordinate frame and the second coordinate frame to obtain a translated azimuth angle measurement.

Clause 2: The method of clause 1, wherein: obtaining the azimuth angle measurement with the first UE comprises performing the azimuth angle measurement with the first UE; translating the azimuth angle measurement between the first coordinate frame and the second coordinate frame comprises translating the azimuth angle measurement from the first coordinate frame to the second coordinate frame; and wherein the method further comprises sending the translated azimuth angle measurement from the first UE to the second UE.

Clause 3: The method of clause 2, wherein the azimuth angle measurement is performed with the first UE as part of a positioning or sensing operation.

Clause 4: The method of clause 1, wherein: obtaining the azimuth angle measurement with the first UE comprises receiving the azimuth angle measurement at the first UE from the second UE; translating the azimuth angle measurement between the first coordinate frame and the second coordinate frame comprises translating the azimuth angle measurement from the second coordinate frame to the first coordinate frame; and wherein the method further comprises performing a positioning or sensing operation at the first UE using the translated azimuth angle measurement.

Clause 5: The method of any one of clauses 1-4, further comprising: determining, at the first UE, a second reference azimuth angle indicative of a relationship between the inter-UE directional vector and the first coordinate frame of the first UE at the first time; and sending the second reference azimuth angle from the first UE to the second UE.

Clause 6: The method of clause 5, wherein the second reference azimuth angle comprises an angle between a fixed axis relative to a body of the first UE and the inter-UE directional vector.

Clause 7: The method of any one of clauses 1-6, wherein determining the inter-UE directional vector between the first UE and the second UE is based on: an angle of departure (AOD) measurement of an RF signal sent from the first UE to the second UE, an angle of arrival measurement (AOA) of an RF signal sent from the second UE to the first UE, a camera or lidar image of the second UE captured by the first UE, a sound measurement of the second UE captured by the first UE, or any combination thereof.

Clause 8: The method of any one of clauses 1-7, wherein the UE comprises a mobile phone or vehicle.

Clause 9: The method of any one of clauses 1-8, wherein receiving the reference azimuth angle comprises receiving the reference azimuth angle via: Sidelink Positioning Protocol (SLPP), Radio Resource Control (RRC), PC5-RRC, application layer signaling, or any combination thereof.

Clause 10: A first user equipment (UE) comprising: at least one transceiver; at least one memory; and at least one processor communicatively coupled with the at least one transceiver and at least one memory, the at least one processor configured to: determine an inter-UE directional vector between the first UE and a second UE within a first coordinate frame of the first UE at a first time; receive, via the at least one transceiver, a reference azimuth angle from the second UE, the reference azimuth angle indicative of a relationship between the inter-UE directional vector and a second coordinate frame of the second UE at substantially the first time; determine, based at least in part on the reference azimuth angle and the inter-UE directional vector, a translation between the first coordinate frame and the second coordinate frame; obtain an azimuth angle measurement with the first UE at a second time subsequent to the first time; and translate the azimuth angle measurement between the first coordinate frame and the second coordinate frame to obtain a translated azimuth angle measurement.

Clause 11: The first UE of clause 10, wherein: to obtain the azimuth angle measurement with the first UE, the at least one processor is further configured to perform the azimuth angle measurement; to translate the azimuth angle measurement between the first coordinate frame and the second coordinate frame, the at least one processor is further configured to translate the azimuth angle measurement from the first coordinate frame to the second coordinate frame; and wherein the at least one processor is further configured to send the translated azimuth angle measurement from the first UE to the second UE.

Clause 12: The first UE of clause 11, wherein the at least one processor is further configured to perform the azimuth angle measurement as part of a positioning or sensing operation.

Clause 13: The first UE of clause 10, wherein: to obtain the azimuth angle measurement with the first UE, the at least one processor is further configured to receive the azimuth angle measurement at the first UE from the second UE; to translate the azimuth angle measurement between the first coordinate frame and the second coordinate frame, the at least one processor is further configured to translate the azimuth angle measurement from the second coordinate frame to the first coordinate frame; and wherein the at least one processor is further configured to perform a positioning or sensing operation at the first UE using the translated azimuth angle measurement.

Clause 14: The first UE of any one of clauses 10-13, wherein the at least one processor is further configured to: determine a second reference azimuth angle indicative of a relationship between the inter-UE directional vector and the first coordinate frame of the first UE at the first time; and send the second reference azimuth angle, via the at least one transceiver, from to the second UE.

Clause 15: The first UE of any one of clauses 10-14, wherein the second reference azimuth angle comprises an angle between a fixed axis relative to a body of the first UE and the inter-UE directional vector.

Clause 16: The first UE of any one of clauses 10-15, wherein, the at least one processor is configured to determine the inter-UE directional vector between the first UE and the second UE based on: an angle of departure (AOD) measurement of an RF signal sent from the first UE to the second UE, an angle of arrival measurement (AOA) of an RF signal sent from the second UE to the first UE, a camera or lidar image of the second UE captured by the first UE, a sound measurement of the second UE captured by the first UE, or any combination thereof.

Clause 17: The first UE of any one of clauses 10-16, wherein the first UE comprises a mobile phone or vehicle.

Clause 18: The first UE of any one of clauses 10-17, wherein the at least one processor is configured to receive the reference azimuth angle from the second UE via: Sidelink Position Protocol (SLPP), Radio Resource Control (RRC), Radio Resource Control (RRC), application layer signaling, or any combination thereof.

Clause 19: A device comprising: means for determining an inter-UE directional vector between a first user equipment (UE) and a second UE within a first coordinate frame of the first UE at a first time; means for receiving a reference azimuth angle from the second UE, the reference azimuth angle indicative of a relationship between the inter-UE directional vector and a second coordinate frame of the second UE at substantially the first time; means for determining, based at least in part on the reference azimuth angle and the inter-UE directional vector, a translation between the first coordinate frame and the second coordinate frame; means for obtaining an azimuth angle measurement at a second time subsequent to the first time; and means for translating the azimuth angle measurement between the first coordinate frame and the second coordinate frame to obtain a translated azimuth angle measurement.

Clause 20: The device of clause 19, wherein: the means for obtaining an azimuth angle measurement comprise means for performing the azimuth angle measurement; the means for translating the azimuth angle measurement between the first coordinate frame and the second coordinate frame comprise means for translating the azimuth angle measurement from the first coordinate frame to the second coordinate frame; and the device further comprises means for sending the translated azimuth angle measurement to the second UE.

Clause 21: An apparatus having means for performing the method of any one of clauses 1-9.

Clause 22: A non-transitory computer-readable medium storing instructions, the instructions comprising code for performing the method of any one of clauses 1-9.

What is claimed is:

1. A method of determining a common azimuth angle between user equipments (UEs), the method comprising:
determining, with a first UE, an inter-UE directional vector between the first UE and a second UE within a first coordinate frame of the first UE at a first time;
receiving, at the first UE, a reference azimuth angle from the second UE, the reference azimuth angle indicative of a relationship between the inter-UE directional vector and a second coordinate frame of the second UE at substantially the first time;
determining, based at least in part on the reference azimuth angle and the inter-UE directional vector, a translation between the first coordinate frame and the second coordinate frame;
obtaining an azimuth angle measurement with the first UE at a second time subsequent to the first time; and
translating the azimuth angle measurement between the first coordinate frame and the second coordinate frame to obtain a translated azimuth angle measurement.

2. The method of claim 1, wherein:
obtaining the azimuth angle measurement with the first UE comprises performing the azimuth angle measurement with the first UE;
translating the azimuth angle measurement between the first coordinate frame and the second coordinate frame comprises translating the azimuth angle measurement from the first coordinate frame to the second coordinate frame; and
wherein the method further comprises sending the translated azimuth angle measurement from the first UE to the second UE.

3. The method of claim 2, wherein the azimuth angle measurement is performed with the first UE as part of a positioning or sensing operation.

4. The method of claim 1, wherein:
obtaining the azimuth angle measurement with the first UE comprises receiving the azimuth angle measurement at the first UE from the second UE;
translating the azimuth angle measurement between the first coordinate frame and the second coordinate frame comprises translating the azimuth angle measurement from the second coordinate frame to the first coordinate frame; and
wherein the method further comprises performing a positioning or sensing operation at the first UE using the translated azimuth angle measurement.

5. The method of claim 1, further comprising:
determining, at the first UE, a second reference azimuth angle indicative of a relationship between the inter-UE directional vector and the first coordinate frame of the first UE at the first time; and
sending the second reference azimuth angle from the first UE to the second UE.

6. The method of claim 5, wherein the second reference azimuth angle comprises an angle between a fixed axis relative to a body of the first UE and the inter-UE directional vector.

7. The method of claim 1, wherein determining the inter-UE directional vector between the first UE and the second UE is based on:
an angle of departure (AOD) measurement of an RF signal sent from the first UE to the second UE,
an angle of arrival measurement (AOA) of an RF signal sent from the second UE to the first UE,
a camera or lidar image of the second UE captured by the first UE,
a sound measurement of the second UE captured by the first UE, or
any combination thereof.

8. The method of claim 1, wherein the UE comprises a mobile phone or vehicle.

9. The method of claim 1, wherein receiving the reference azimuth angle comprises receiving the reference azimuth angle via:
Sidelink Positioning Protocol (SLPP),
Radio Resource Control (RRC),
PC5-RRC,
application layer signaling, or
any combination thereof.

10. A first user equipment (UE) comprising:
at least one transceiver;
at least one memory; and
at least one processor communicatively coupled with the at least one transceiver and at least one memory, the at least one processor configured to:
determine an inter-UE directional vector between the first UE and a second UE within a first coordinate frame of the first UE at a first time;
receive, via the at least one transceiver, a reference azimuth angle from the second UE, the reference azimuth angle indicative of a relationship between the inter-UE directional vector and a second coordinate frame of the second UE at substantially the first time;
determine, based at least in part on the reference azimuth angle and the inter-UE directional vector, a translation between the first coordinate frame and the second coordinate frame;
obtain an azimuth angle measurement with the first UE at a second time subsequent to the first time; and
translate the azimuth angle measurement between the first coordinate frame and the second coordinate frame to obtain a translated azimuth angle measurement.

11. The first UE of claim 10, wherein:
to obtain the azimuth angle measurement with the first UE, the at least one processor is further configured to perform the azimuth angle measurement;
to translate the azimuth angle measurement between the first coordinate frame and the second coordinate frame, the at least one processor is further configured to translate the azimuth angle measurement from the first coordinate frame to the second coordinate frame; and
wherein the at least one processor is further configured to send the translated azimuth angle measurement from the first UE to the second UE.

12. The first UE of claim 11, wherein the at least one processor is further configured to perform the azimuth angle measurement as part of a positioning or sensing operation.

13. The first UE of claim 10, wherein:
to obtain the azimuth angle measurement with the first UE, the at least one processor is further configured to receive the azimuth angle measurement at the first UE from the second UE;
to translate the azimuth angle measurement between the first coordinate frame and the second coordinate frame, the at least one processor is further configured to translate the azimuth angle measurement from the second coordinate frame to the first coordinate frame; and
wherein the at least one processor is further configured to perform a positioning or sensing operation at the first UE using the translated azimuth angle measurement.

14. The first UE of claim 10, wherein the at least one processor is further configured to:
determine a second reference azimuth angle indicative of a relationship between the inter-UE directional vector and the first coordinate frame of the first UE at the first time; and
send the second reference azimuth angle, via the at least one transceiver, from to the second UE.

15. The first UE of claim 14, wherein the second reference azimuth angle comprises an angle between a fixed axis relative to a body of the first UE and the inter-UE directional vector.

16. The first UE of claim 10, wherein, the at least one processor is configured to determine the inter-UE directional vector between the first UE and the second UE based on:
an angle of departure (AOD) measurement of an RF signal sent from the first UE to the second UE,
an angle of arrival measurement (AOA) of an RF signal sent from the second UE to the first UE,
a camera or lidar image of the second UE captured by the first UE,
a sound measurement of the second UE captured by the first UE, or
any combination thereof.

17. The first UE of claim 10, wherein the first UE comprises a mobile phone or vehicle.

18. The first UE of claim 10, wherein the at least one processor is configured to receive the reference azimuth angle from the second UE via:
Sidelink Position Protocol (SLPP),
Radio Resource Control (RRC),
Radio Resource Control (RRC),
application layer signaling, or
any combination thereof.

19. A device comprising:
means for determining an inter-UE directional vector between a first user equipment (UE) and a second UE within a first coordinate frame of the first UE at a first time;
means for receiving a reference azimuth angle from the second UE, the reference azimuth angle indicative of a relationship between the inter-UE directional vector and a second coordinate frame of the second UE at substantially the first time;
means for determining, based at least in part on the reference azimuth angle and the inter-UE directional vector, a translation between the first coordinate frame and the second coordinate frame;
means for obtaining an azimuth angle measurement at a second time subsequent to the first time; and
means for translating the azimuth angle measurement between the first coordinate frame and the second coordinate frame to obtain a translated azimuth angle measurement.

20. The device of claim 19, wherein:
the means for obtaining an azimuth angle measurement comprise means for performing the azimuth angle measurement;
the means for translating the azimuth angle measurement between the first coordinate frame and the second coordinate frame comprise means for translating the azimuth angle measurement from the first coordinate frame to the second coordinate frame; and
the device further comprises means for sending the translated azimuth angle measurement to the second UE.
